(19) United States
(12) Patent Application Publication
(10) Pub. No.: US 2025/0067674 A1
(43) Pub. Date: Feb. 27, 2025

(54) CHIPS AND METHODS

(71) Applicant: Imperial College Innovations Ltd, London (GB)

(72) Inventors: Mary Ryan, London (GB); Fang Xie, London (GB); Sarah Madeline Fothergill, London (GB)

(21) Appl. No.: 18/549,950

(22) PCT Filed: Mar. 11, 2022
(86) PCT No.: PCT/GB22/50631

§ 371 Date: Sep. 11, 2023

(30) Foreign Application Priority Data
Mar. 11, 2021 (GB) 2103385.7

(51) Int. Cl. G01N 21/64

(52) U.S. Cl. CPC G01N 21/648; G01N 21/6452; G01N 2021/6441

(57) ABSTRACT

The present invention relates to the metal enhanced fluorescence and chips designed to improve the usefulness of current chips. Specifically, the chips of the present invention are able to enhance fluorescence from a range of spectral regions.

### FIELD

The invention is in the field of analyte detection, and in particular in the field of fluorescence based analyte detection.

### BACKGROUND

Fluorescence based detection of analytes or biomarkers, such as proteins, nucleic acids, small molecules etc is routinely used in many fields, including medical diagnostics, environmental biosensing, and research.

Standard fluorescence based detection relies on the detection of emitted light. For sensitive detection purposes, the emitted light is typically only present when the target analyte is present. For example such methods are routinely used in ELISA based assays, wherein a solid surface can be coated with a molecule capable of specifically binding to the analyte—a capture molecule. Exposure to the analyte causes the analyte to be localised to the solid surface (via the capture molecule). A secondary molecule (detection molecule), for example, an antibody, can then be used to detect the presence of the bound analyte. The secondary molecule can be labelled with a fluorophore, and detection of the emitted light indicates the presence of the target analyte on the solid surface. In other ELISA based methods, the analyte itself is already labelled with the fluorophore, either directly or indirectly, prior to capture by the surface bound capture molecule, localising the fluorescent marker to specific locations on the solid surface.

Such approaches are routinely used in medical diagnostics. For example PCR based methods to detect the presence of pathogens, or disease states such as cancer, routinely use fluorescently labelled probes; and ELISA methods as described above are also used.

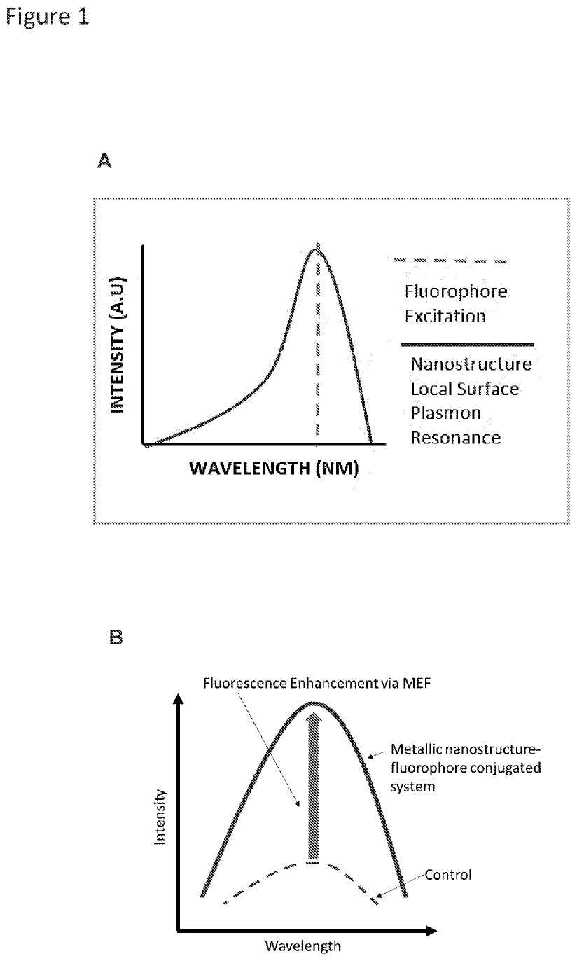

Whilst fluorescent based methods are typically relatively sensitive, there is always a drive to detect smaller and smaller quantities of an analyte of biomarker. This would allow earlier detection of a disease state, for example, or other changes in the state of biological systems. Increased sensitivity is also useful in environmental biosensing. One method currently used to increase the intensity of the emitted light from a fluorophore is ‘Metal Enhanced Fluorescence’ (MEF). MEF increases the intensity of a fluorescent (light) signal by placing a metallic nanostructure in close proximity to the fluorophore. Briefly, these metallic nanostructures possess free surface electrons which resonate when illuminated with light leading to oscillations of the charge density, which is termed localised surface plasmon resonance (LSPR). This LSPR can be measured for a given nanostructure and observed as a ‘peak’ in extinction, i.e. absorption and scattering (FIG. 1A). Providing the nanostructure LSPR and fluorophore excitation overlap, MEF can be observed. Here, upon placing a fluorophore close to this metallic surface, the properties of the fluorophore are modified such that there is an increase in its excitation and its emission rate is enhanced. This may be thought of as the presence of the metal providing additional ‘hot spots’ to excite the fluorophore further, thus leading to increased fluorescence.

In the field of biological sensing and imaging, each spectral region may be associated with a particular application and thus has its own advantages both practically and scientifically. For example, when considering UV, many biomolecules absorb light in the range of 220-280 nm, which allows for label free detection with these molecules acting as natural fluorophores. This however is hindered due to the low efficiency of native biomolecule fluorescence[9]. The use of visible fluorophores still remains dominant in the field of fluorescence sensing, the most noteworthy for fluorophores, which include FITC's, and spanning from UV to visible wavelengths are the frequently used Alexa Fluor family of fluorescent dyes[10]. Near Infra-red wavelengths are advantageous when considering biosensing or imaging through biological matter of fluids. Haemoglobin and water absorb shorter wavelengths and thus there is low transparency for traditional visible fluorophores in this spectral region[11]. Two emission bands have been identified with higher transparency through biological medium biological fluid[12-14] are NIR-I (650-900 nm) and NIR-II (1000 nm-1700 nm)[15] which have attracted attention from fluorescence guided surgical imaging to biosensing and imaging [14,16,17]. Because of the very low quantum yields of the NIR fluorophores currently available[18], and poor instrumentation detectors available for this wavelength region, there has been a desire for NIR MEF[4][19, 20].

For MEF to occur, fluorophores are required to be in close proximity to the surface of the metallic nanostructure[24](in the range of 5 to 30 nm). Metal nanoparticles possess surface electrons which resonate when excited with light, causing the electrons to be displaced, and the oscillation of charge density[25]. This is deemed as local surface plasmon resonance (LSPR) and is one of the main contributors to MEF's significant fluorescent enhancement. The LSPR occurs when the wavelength of the incident light is larger than that of the dimensions of the nanostructure. In contrast, surface plasmon polarations (SPP) are propagating charge oscillations on the surface of thin metal films but cannot be excited by free-space radiation; instead, they require a momentum matching, such as through periodicity in a nanostructure, for resonance excitation[4]. There are many parameters that affect the plasmonic properties of a nanostructure such as morphology, material and nearby particles and thus in the past decade, there have been plentiful novel nanoparticle structures showing the ability to improve both the fluorescence intensity and photostability of fluorophores via this mechanism, including that of nanorods[26], nanocubes[27], nanodisks[28], nanotriangles[29] and nanostars[3]. To date, many structures fabricated for MEF have consisted primarily of silver or gold, due to their LSPRs already being within the visible to near infrared wavelengths[30,31][32]. However, gold is high in cost thus limits its applicability for healthcare applications.

The present invention provides improved devices and chips for using MEF to increase emitted light from one or more fluorophores, and also provides associated methods, uses, kits and reagents.

### SUMMARY OF PRESENT INVENTION

The inventors have surprisingly found that chips comprising a plurality of particular nanostructures has improved MEF properties. For example, the chips of the invention allow the MEF of fluorophores from distinct spectral regions, from UV to near infrared-II (NIR-II), simultaneously. This allows the emissions from multiple different fluorophores to be enhanced simultaneously with a single platform, which is not possible with current MEF technology. Each spectral region represents a unique application, meaning that the chips of the invention are more widely applicable. Table 1 shows the different spectral regions:

TABLE 1
Spectra Regions and common applications

| Spectral Region | Application |
|---|---|
| UV (250-400 nm) | Protein Fluorescence |
| Visible (400-700 nm) | Simple Processing, Widely Available |
| Near Infra Red −1 (650-900 nm) | Low Absorption in Biological Medium |
| Near Infra Red-II | Very Low Absorption |
| (1000-1700 nm) | Biological Medium |

The ability of the chips of the invention to cause MEF in the NIR-II region is particularly advantageous since there is significantly less interference from water and biological tissues such as haemoglobin, and is more suitable for use in biological media such as blood.

The chips of the invention allow for multiplexed biosensing based on MEF across multiple spectral regions covering from UV to NIR-II. Existing technologies focus on enhancing one spectral region, resulting in multiple platforms being required for different spectral regions. Therefore a chip of the invention with the ability to cause MEF across multiple spectral regions makes it particularly suitable for inclusion in fluorescence biosensing technologies such as inclusion in hardware such as plate readers, removing the need to use multiple different chips, or remove and change the chips between applications.

It is thought that the multiple plasmonic peaks may be due to higher order of mode in addition to dipole mode (a primary feature), as well as hybrid mode induced by a coupling affect between adjacent nanostructures.

These optical properties are crucial for the development of multiplexed and multicolour biosensing applications.

The chips of the invention can also be tuned to allow MEF for particular fluorophores or sets of fluorophores, and can be tuned for use in particular applications.

### DETAILED DESCRIPTION OF THE INVENTION

The invention provides a nanostructure as described herein, and a composition of nanostructures as described herein, and also provides chips, methods, devices and compositions, including methods of pathogen or disease state detection and/or diagnosis. The invention also provides a biosensor comprising the chip of the invention, and a detection system comprising the chip of the invention.

In a first aspect, the invention provides a chip comprising a solid substrate and a plurality of nanostructures, wherein the plurality of nanostructures are arranged on the surface of the solid substrate, and wherein the nanostructures comprise a dialectic core partially coated in a metallic plasmonic material.

A nanostructure comprises a dielectric core partially coated in a metallic plasmonic material.

By dielectric core, we include the meaning of the inner core of the nanostructure, once the dielectric core is at the required size.

By dielectric nanoparticle we include the meaning of the initial dielectric particle that is arranged on the surface of the substrate, prior to modification, for example by etching. The skilled person will be aware of means to reduce the size of the dielectric particle, or otherwise alter the shape of the dielectric particle—for example RIE. Typically the dielectric particle is modified, e.g. by etching, to reduce the diameter to the required size. However in some embodiments the dielectric particle is already at the required size and not size reduction, e.g. etching, is required. Once the dielectric nanoparticle has been modified ready for metallic coating, it is termed the dielectric core.

The skilled person will understand what is meant by a chip in the present context. Essentially a chip is a physical entity with a surface that is typically used to detect the presence or, or amount of, an analyte or a biomarker. The chip of the present invention can be considered to be a biochip. The chip may be any physical entity, for example may take the form of a slide, a dish, a lateral flow strip, a multi-well plate for example a standard multi-well plate, such as a 48 or 96 well plate coated with the nanostructures described herein can be considered to be a chip of the invention. A bead coated with the nanostructures described herein is also considered to be a chip of the invention.

The chip of the present invention comprises a plurality of nanostructures arranged on the surface of the solid substrate. The chip in some embodiments can also comprise an analyte detecting agent and has for example a functionalised surface. In other embodiments the chip of the invention does not comprise an analyte detecting agent but is suitable for subsequent functionalisation with an analyte detecting agent.

The chip of the present invention essentially comprises a plurality of nanostructures that themselves are not necessarily capable of interacting specifically with a target analyte, but which, upon irradiation with the correct wavelength or wavelengths of radiation, form a localised surface plasmon resonance (LSPR). The LSPR can enhance the fluorescence emission of a nearby fluorophore. The fluorophore can be bought into proximity with the LSPR through a specific interaction with, for example, an antibody conjugated to the nanostructures.

The skilled person will understand what is meant by the term nanostructures, which is a term used by those in the field. Chips, or biosensors, that are capable of MEF and that are used to detect biomolecules or other molecules and that comprise nanostructures are known, see for example Fothergill et al 2018 Nanoscale 10: 20914; and Jeong et al 2018 Biosensors and Bioelectronics 111: 102-116.

Typically the average diameter of each metallic material-coated nanostructure of the invention is considered to be:
between 1 nm and 1000 nm, optionally between 50 nm and 900 nm; 100 nm and 800 nm; 200 nm and 700 nm; 300 nm and 600 nm, 400 and 500 nm; and/or
at least 1 nm, 50 nm, 100 nm, 200 nm, 300 nm, 400 nm, 500 nm, 600 nm, 700 nm, 800 nm, 900 nm and 1000 nm; and/or
less than 1000 nm, 900 nm, 800 nm, 700 nm, 600 nm, 500 nm, 400 m, 300 nm, 200 nm, 100 nm, 50 nm, 25 nm, or 5 nm, or 1 nm.

By a plurality of we include the meaning of any amount of from at least 2. Typically the nanostructures will essentially cover the surface of the substrate. In preferred embodiments the nanostructures are not in contact with one another, i.e. none of the nanostructures touch another nanostructure, i.e. in preferred embodiments the nanostructures are spatially separated from one another.

In some embodiments one or more of the nanostructures are in contact with one or more other nanostructures. In preferred embodiments the nanostructures are regularly arrayed and each nanostructure does not contact another nanostructure.

The measurements described herein, for example of the size of the etched dielectric core, the size of the capped nanostructure etc have been determined using electron microscopy, which involves coating the structures in a 10 nm layer of chromium, for imaging purposes. The person skilled in electron microscopy practices will appreciate that a 10 nm layer of material applied for imaging purposes may not be an even layer of 10 nm, and may vary from between 5 nm and 15 nm in thickness. The skilled person is aware of this and is able to take this into account when determining parameters of the nanostructures described herein. Accordingly, in some embodiments the dimensions described herein are the dimensions as determined using electron microscopy with a 10 nm layer of chromium (see for example Example 2 which describes the use of chromium in imaging). Accordingly, in some embodiments the actual dimensions of the particles and layers described are from 10 nm to 3 0 nm less than the dimension reported herein.

Accordingly in some embodiments the average diameter of each chromium coated, metallic material-coated nanostructure of the invention is considered to be:
between 1 nm and 1000 nm, optionally between 50 nm and 900 nm; 100 nm and 800 nm; 200 nm and 700 nm; 300 nm and 600 nm, 400 and 500 nm; and/or
at least 1 nm, 50 nm, 100 nm, 200 nm, 300 nm, 400 nm, 500 nm, 600 nm, 700 nm, 800 nm, 900 nm and 1000 nm; and/or
less than 1000 nm, 900 nm, 800 nm, 700 nm, 600 nm, 500 nm, 400 m, 300 nm, 200 nm, 100 nm, 50 nm, 25 nm, or 5 nm, or nm,
as determined by electron microscopy.

In some embodiments the substrate is coated in the plurality of nanostructures.

In preferred embodiments the nanostructures are arranged on the surface of the substrate in a single layer.

The arrangement of the nanostructures on the surface of the substrate can be any arrangement. In preferred embodiments, at least a portion of the plurality of nanostructures is arranged upon said substrate to form a first array. In preferred embodiments, the first array is a first regular array of nanostructures. The regular array may be any known regular array pattern. However, preferably the first array is a close packed array, for example is a hexagonal close packed array (hcp) or an face-centred cubic (fcc) array, and more preferably is a hexagonal close packed array (hcp). For example in some embodiments the nanoparticles are arranged in a hcp wherein the nanoparticles are spatially separated from one another.

In preferred embodiments, the chips of the present invention are capable of simultaneously enhancing fluorescence from fluorophores with maximum excitation wavelengths in different spectral regions. It is considered that this property is a feature of both the relative arrangement of the nanostructures, the size of the nanostructures, the thickness of the metallic coating, and also the type of metallic material used. Each of these properties can be tuned to modulate the different LSPRs that are formed on different portions of the nanoparticle/substrate (e.g. between nanoparticles, between the nanoparticles and the substrate for example) to produce a chip that is capable of enhancing fluorescence of the required fluorophores. Accordingly, the hcp arrangement is just one suitable arrangement, and the skilled person will be aware of other suitable arrangements of the nanoparticles.

The arrangement of the nanoparticles may be a random arrangement. However, preferably the arrangement of nanostructures is not random, for example is a regular arrangement.

The skilled person will appreciate that a single chip may comprise a number of different regions wherein the properties of the nanostructures and the LSPRs that are induced are different. For example, in one embodiment the chip comprises at least two different regions wherein in each region the properties and/or arrangement of the nanostructures is different. The chip may comprise at least 2, 3, 4, 5, 6, 7, 8, 9 or at least 10 different regions wherein the properties and/or arrangement of nanostructures is different.

For example in one embodiment the arrangement of the nanostructures may be different between different regions, for example the spatial separation of the nanostructures may be different between different regions, or the formation of the nanostructures may be different between different regions, for example in one region the arrangement may be hcp, and in another region is may be a fcc array. In other embodiments the dielectric particle which is manipulated to become the dielectric core of the nanoparticle may have been manipulated, for example etched, for different lengths of time in different regions of the chip.

In preferred embodiments, the arrangement of the nanostructures, and the composition of the nanostructures themselves, are the same across the entire chip.

By partially coated we include the meaning of the dielectric core being coated on the outer surface with the metallic material wherein:
at least 30%, 35%, 40%, 45%, 50%, 55%, 60%, 65%, 70%, 75%, 80%, 85%, 90%, 95%, 96%, 97%, 98%, 99%, of the surface of each of the nanostructures of the plurality is coated with the metallic material; and/or
wherein less than 99%, 98%, 97%, 96%, 95%, 90%, 85%, 80%, 75%, 70%, 65%, 60%, 55%, 50%, 45%, 40%, 35%, 30% of the surface of each of the nanostructures of the plurality is coated with the metallic material.

In instances where the dielectric core is located on the surface of the substrate prior to application of the metallic coating, the skilled person will appreciate that it would be impossible to coat the dielectric core 100% in the metal. In preferred embodiments, less than 100% of the nanostructure surface is coated in the metallic material. In some embodiments the dielectric core is not 100% coated in the metallic plasmonic material.

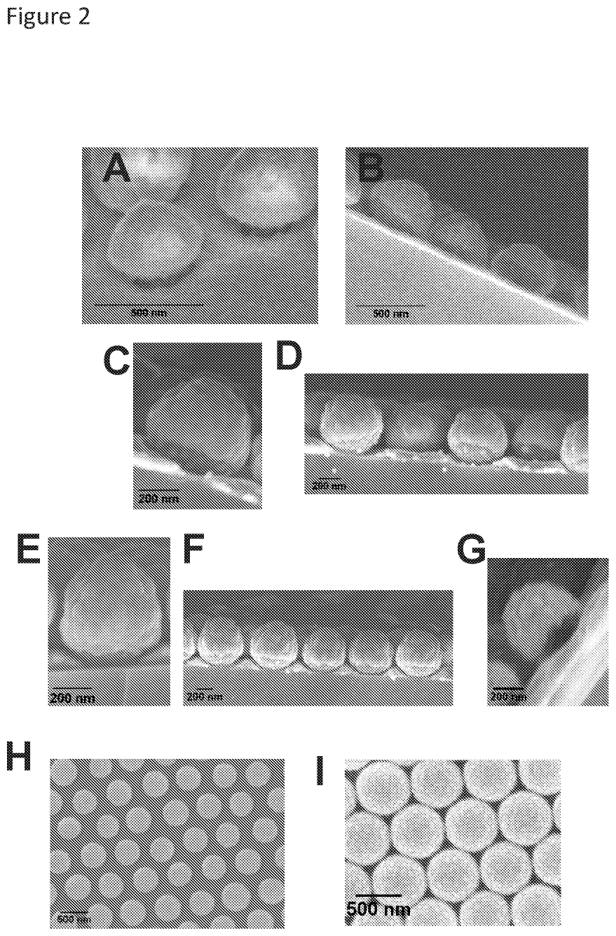

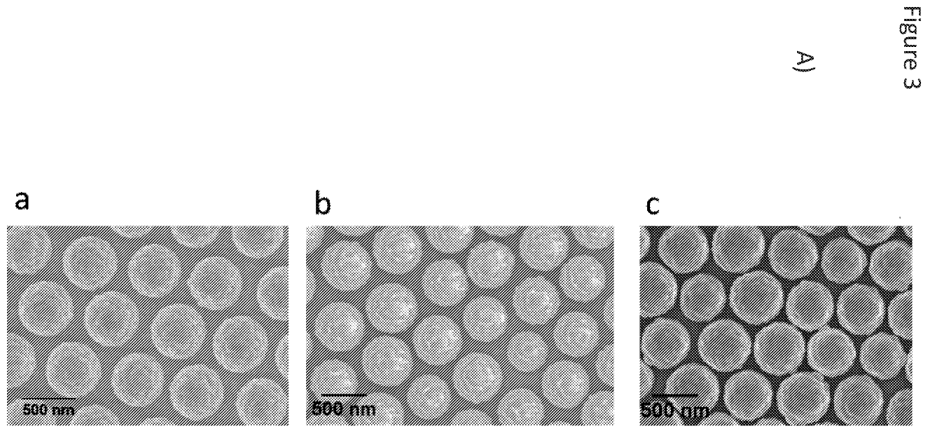

Preferably the partial coating of the metallic plasmonic material forms a cap structure on the dielectric core. In some embodiments the capped structure is known in the art as a “half-shell”. The skilled person will understand what is meant by a cap structure, and such a structure is shown in for example FIG. 2b. In this preferred embodiment, the metallic coating is positioned on top of the dielectric core, i.e. on the surface which is not the surface that is in contact with the substrate, and is the surface which is opposite to the surface that is in contact with the substrate. In one embodiment then the cap structure is positioned distal to the portion of the dielectric core that contacts the surface of the solid substrate.

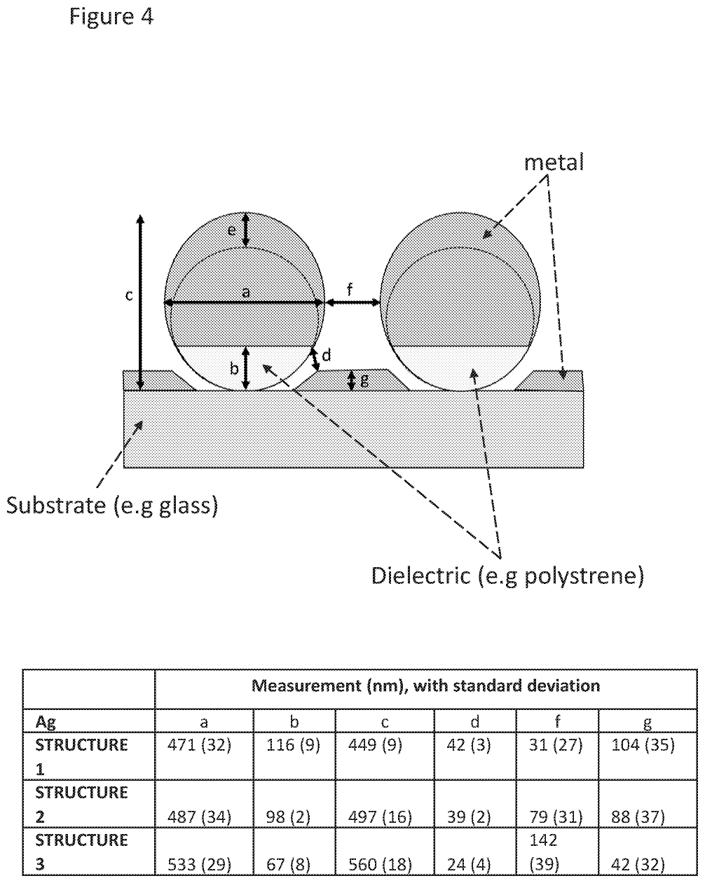

In some embodiments, the metallic cap structure continues down the side of the dielectric core, but does not make contact with the underlying substrate. It is preferred if the dielectric core is exposed to the surrounding media in a region below the capped metallic structure and above the substrate. This region is shown in FIG. 4 as (b). Accordingly, in one embodiment a portion of the dielectric core remains exposed, i.e. a portion of the dielectric core is not coated with the metallic plasmonic material and is not in contact with the solid substrate, optionally wherein distance (g) is not coated with the metallic plasmonic material.

It is considered key that the cap structure is maintained, i.e. there is a circumferential exposed area of the dielectric core going around the dielectric core, separating the metallic cap from the substrate below.

In some embodiments then the metallic material does not form a continuous film over the dielectric cores, contacting the underlying substrate.

In one embodiment the cap structure has a cap edge, optionally wherein the distance (b) between the cap edge and the surface of the solid substrate is:
from 1 nm and 250 nm, optionally from 2 nm and 240 nm, 3 nm and 230 nm, 3 nm and 220 nm, 5 nm and 200 nm, 10 nm and 190 nm, 15 nm and 180 nm, 20 nm and 170 nm, 25 nm and 160 nm, 30 nm and 150 nm, 40 nm and 140 nm, 50 nm and 130 nm, 60 nm and 120 nm, 70 nm and 110 nm, 80 nm and 100 nm optionally around 90 nm; and/or
at least 1 nm, or at least 2, 3, 4, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240 or at least 250 nm; and/or
is less than 250 nm, or less than 240, 230, 220 210, 200, 190, 180, 170, 160, 150, 140, 130, 120, 110, 100, 95, 90, 85, 80, 75, 70, 65, 60, 55, 50, 45, 40, 35, 30, 25, 20, 15, 10, 5, 4, 3, 2, or less than 1 nm.

As described above, the dimensions referred to herein are typically those dimensions that are determined using electron microscopy, which involves coating the chip and/or particles and/or dielectric cores with a 10 nm layer of chromium. Accordingly, in some embodiments the cap structure has a cap edge, optionally wherein when the chip of the invention is coated with a 10 nm layer of chromium or other metal used for imaging purposes such as gold or other conductive material, the distance (b) between the cap edge and the surface of the solid substrate is:
from 1 nm and 250 nm, optionally from 2 nm and 240 nm, 3 nm and 230 nm, 3 nm and 220 nm, 5 nm and 200 nm, 10 nm and 190 nm, 15 nm and 180 nm, 20 nm and 170 nm, 25 nm and 160 nm, 30 nm and 150 nm, 40 nm and 140 nm, 50 nm and 130 nm, 60 nm and 120 nm, 70 nm and 110 nm, 80 nm and 100 nm optionally around 90 nm; and/or
at least 1 nm, or at least 2, 3, 4, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240 or at least 250 nm; and/or
is less than 250 nm, or less than 240, 230, 220 210, 200, 190, 180, 170, 160, 150, 140, 130, 120, 110, 100, 95, 90, 85, 80, 75, 70, 65, 60, 55, 50, 45, 40, 35, 30, 25, 20, 15, 10, 5, 4, 3, 2, or less than 1 nm,
as determined by electron microscopy.

As described above, in some embodiments the plurality of nanostructures all comprise the same dielectric core and/or the same metallic material. In the same or different embodiments the plurality of nanostructures all comprise the same thickness of metallic cap, surface area coated in the metallic cap, and/or spatial arrangement.

In other embodiments as described above, the chip may comprise a number of regions in which the features and properties of the nanostructures of one region differ to the features and properties of the nanostructures of a second region.

Accordingly in some embodiments at least one nanostructure of the plurality of nanostructures comprises a different dielectric material and/or different metallic material to the other nanostructures of the plurality of nanostructures.

The skilled person will understand what is meant by the term dielectric material.

A dielectric material is a substance that is a poor conductor of electricity, but an efficient supporter of electrostatic field. The dielectric material may be any dielectric material. In some embodiments the dielectric material is a polymer. In some embodiments the dielectric material is a polymer selected from the group comprising or consisting: polystyrene, silica or any combination thereof. In preferred embodiments the dielectric material is polystyrene.

In some embodiments the dielectric core is not a metallic material.

In some embodiments the nanostructures comprise only one type of metallic material.

In some embodiments the metallic material is not gold. In some embodiments the nanoparticle comprises only one metal and the metal is not gold.

In some embodiments the caps on the dielectric cores comprise a number of different metals, for example copper and aluminium. The different metals may be applied as sequential layers, for example an inner layer that contacts the dielectric core of a first metal, and a second outer later of a second metal.

MEF is a known phenomenon and the skilled person will be aware of suitable plasmonic metallic materials that are suitable for use with MEF. In some embodiments the metallic material is selected from:
a noble metal;
a base metal, or a salt thereof;
or any combination thereof.

In some embodiments, the metallic material is a plasmonic material, optionally selected from silver, gold, copper and aluminium, or selected from silver, gold and aluminium. In some embodiments the metallic material is a plasmonic material, but is not gold. In some embodiments the nanostructure does not comprise a single layer of metallic material that is copper, i.e. may comprise a layer of copper and a layer of aluminium for instance, but does not comprise only copper.

In some embodiments the metallic material is selected from the group comprising or consisting: silver, gold, copper or aluminium.

In a preferred embodiment the metallic material is silver.

In one embodiment, the nanostructures and chip do not comprise de-alloyed Ag/Au film.

It is preferred if the partial metallic coating is contiguous. i.e. although the surface of the dielectric core is, in some embodiments for example, only 50% coated with the metallic material, this 50% coating could be in multiple smaller discrete patches. It is preferred if the coating that is capping the dielectric core is one contiguous layer, for example a film, of metallic material, rather than a plurality of smaller metallic islands.

As described above, the spacing and relative sizes of the nanostructures is considered to influence the LSPRs produced, and can be readily tuned by the skilled person to provide a chip with the required properties. These properties can be readily tuned during the fabrication process. Detecting the presence and properties of the LSPRs produced is routine for the skilled person. Briefly, one method of fabricating the chips of the present invention involves forming a self-assembled monolayer of dielectric particles such as polystyrene particles on a substrate surface, for example on a glass surface. The monolayer of dielectric particles can be deposited on the surface of the substrate through a process known as self-assembled monolayer formation, where the particles are floated on the interface of a liquid at which point they self-order. Perpendicular extraction of the substrate from the liquid results in the particles being deposited on the surface of the substrate. In some embodiments the particles are then “etched”, for example using reactive ion etching, for example oxygen plasma (RIE) (typically at 100 W but other parameters are also suitable). The etching results in the dielectric cores being formed to the correct size, and also that an appropriate distance between the particles is achieved. Etching can result in the size of the initial dielectric core being reduced by around 5%, 10%, 15%, 20%, 25%, 30%, 35%, 40%, 45%, 50%, 55%, 60%, 65%, 70% or 75%. Etching is known in the field. In this way, the original pitch length of the polystyrene (centre to centre distance) is maintained.

Accordingly, in some embodiments the dielectric nanoparticles are etched to a sufficient degree and/or length of time so as to result in the formation of a dielectric core with a diameter that is 100%, 95%, 90%, 85%, 80%, 75%, 70%, 65%, 60%, 55%, 50%, 45%, 40%, 35%, 30% or 25% of the size of the diameter of the initial dielectric nanoparticle. In some instances the dielectric nanoparticle is not etched at all, i.e. has an etch time of 0 seconds, and has a diameter that is 100% of the diameter of the initial dielectric nanoparticle.

In some embodiments it is considered advantageous if the size of the nanoparticles is not entirely uniform. For example in some embodiments it is considered that the advantageous properties of the invention arises or may arise from the non-uniformity of the sizes of the dielectric core and/or metallic metal coated nanoparticle.

In some embodiments the average diameter of the dielectric core has a standard deviation of:
a) At least 1 nm, or at least 5, 10, 15, 20, 25, 30, 35, 40, 45, 50, 55, 60, 65, 70, 75, 80, 85, 90, 95 or at least 100 nm;
b) Less than 100 nm for example less than 95, 90, 85, 80, 75, 70, 65, 60, 55, 50, 45, 40, 35, 30, 25, 20, 15, 10, 5 or less than 1 nm;
c) Between 1 nm and 100 nm, for example between 5 and 95, 10 and 90, 15 and 85, 20 and 80, 25 and 75, 30 and 70, 35 and 65, 40 and 60, 45 and 55 nm.

In some embodiments the average diameter of metallic material-coated nanostructures has a standard deviation of:
a) At least 1 nm, or at least 5, 10, 15, 20, 25, 30, 35, 40, 45, 50, 55, 60, 65, 70, 75, 80, 85, 90, 95 or at least 100 nm;
b) Less than 100 nm for example less than 95, 90, 85, 80, 75, 70, 65, 60, 55, 50, 45, 40, 35, 30, 25, 20, 15, 10, 5 or less than 1 nm;
c) Between 1 nm and 100 nm, for example between 5 and 95, 10 and 90, 15 and 85, 20 and 80, 25 and 75, 30 and 70, 35 and 65, 40 and 60, 45 and 55 nm.

In some embodiments the average diameter of chromium-coated, metallic material-coated nanostructures has a standard deviation of:
a) At least 1 nm, or at least 5, 10, 15, 20, 25, 30, 35, 40, 45, 50, 55, 60, 65, 70, 75, 80, 85, 90, 95 or at least 100 nm;
b) Less than 100 nm for example less than 95, 90, 85, 80, 75, 70, 65, 60, 55, 50, 45, 40, 35, 30, 25, 20, 15, 10, 5 or less than 1 nm;
c) Between 1 nm and 100 nm, for example between 5 and 95, 10 and 90, 15 and 85, 20 and 80, 25 and 75, 30 and 70, 35 and 65, 40 and 60, 45 and 55 nm.

Following etching, the metallic material is deposited on to the dielectric cores. In some embodiments the substrate surface is also coated in the metallic material. In preferred embodiments the surface of substrate is coated in a continuous metal layer, or metal film. In other embodiments the substrate surface is not coated in the metallic material. In preferred embodiments, the metallic material is deposited by sputtering. Other methods such as thermal deposition may also be suitable, but in some embodiments it is considered that particular characteristics of the chip are achieved when the metallic material is sputtered.

In some embodiments the metallic material is also deposited on the substrate surface, forming a continuous layer of metallic material between the nanostructures.

In one embodiment where the surface of the substrate comprises a metal film, the distance between the cap edge and the surface of the metal film is:
from 1 nm and 250 nm, optionally from 2 nm and 240 nm, 3 nm and 230 nm, 3 nm and 220 nm, 5 nm and 200 nm, 10 nm and 190 nm, 15 nm and 180 nm, 20 nm and 170 nm, 25 nm and 160 nm, 30 nm and 150 nm, 40 nm and 140 nm, 50 nm and 130 nm, 60 nm and 120 nm, 70 nm and 110 nm, 80 nm and 100 nm optionally around 90 nm; and/or
at least 1 nm, or at least 2, 3, 4, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240 or at least 250 nm; and/or
is less than 250 nm, or less than 240, 230, 220 210, 200, 190, 180, 170, 160, 150, 140, 130, 120, 110, 100, 95, 90, 85, 80, 75, 70, 65, 60, 55, 50, 45, 40, 35, 30, 25, 20, 15, 10, 5, 4, 3, 2, or less than 1 nm;
optionally wherein the distance (g) is 24 nm or 42 nm.

In some embodiments where the surface of the substrate comprises a metal film, and where the chip of the invention is coated with a 10 nm layer of chromium or other metal used for imaging purposes such as gold or other conductive material, the distance between the cap edge and the surface of the metal film is:
from 1 nm and 250 nm, optionally from 2 nm and 240 nm, 3 nm and 230 nm, 3 nm and 220 nm, 5 nm and 200 nm, 10 nm and 190 nm, 15 nm and 180 nm, 20 nm and 170 nm, 25 nm and 160 nm, 30 nm and 150 nm, 40 nm and 140 nm, 50 nm and 130 nm, 60 nm and 120 nm, 70 nm and 110 nm, 80 nm and 100 nm optionally around 90 nm; and/or
at least 1 nm, or at least 2, 3, 4, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240 or at least 250 nm; and/or
is less than 250 nm, or less than 240, 230, 220 210, 200, 190, 180, 170, 160, 150, 140, 130, 120, 110, 100, 95, 90, 85, 80, 75, 70, 65, 60, 55, 50, 45, 40, 35, 30, 25, 20, 15, 10, 5, 4, 3, 2, or less than 1 nm;
optionally wherein the distance (g) is 24 nm or 42 nm,
as determined by electron microscopy.

The skilled person will appreciate that the size of the dielectric core prior to metallic material deposition influences how thick the metal layer can be. If the metallic layer is too thick relative to the size of the core, it will risk contacting the underlying substrate, and effectively forming a continuous layer. It is considered that, depending on the imaging technique used, a distance of 5 nm between the cap edge and the underlying substrate is sufficiently large to still be able to distinguish between the formation of the desired capped structure, versus the undesired continuous film structure. For example, using TEM a distance of 5 nm can be distinguished (when the chip is coated with a 10 nm layer of chromium or other metal used for imaging purposes such as gold or other conductive material). Using SEM the resolution is such that a distance of 20 nm may be distinguished (when the chip is coated with a 10 nm layer of chromium or other metal used for imaging purposes such as gold or other conductive material). The important factor is that the metallic material forms a cap structure on the dielectric core and does not contact the underlying substrate.

There are typically two measurements that can be used to describe the size of the nanostructures. One is the diameter of the uncoated dielectric core, e.g. the size of the dielectric structures after the etching step described above; and the second is the diameter of the metallic coated nanostructure, e.g. after the metallic material is deposited on the dielectric core.

In one embodiment the average diameter of the dielectric core is:
from 1 nm to 1000 nm, optionally from 50 nm to 900 nm; 100 nm to 800 nm; 200 nm to 700 nm; 300 nm to 600 nm, 400 to 500 nm; and/or
at least 1 nm, 50 nm, 100 nm, 200 nm, 300 nm, 400 nm, 500 nm, 600 nm, 700 nm, 800 nm, 900 nm and 1000 nm; and/or
less than 1000 nm, 900 nm, 800 nm, 700 nm, 600 nm, 500 nm, 400 m, 300 nm, 200 nm, 100 nm, 50 nm, 25 nm, or 5 nm, or nm.

In some embodiments the average diameter of each metallic material-coated nanostructure of the plurality of nanostructures is:
from 1 nm to 1000 nm, optionally from 50 nm to 900 nm; 100 nm to 800 nm; 200 nm to 700 nm; 300 nm to 600 nm, 400 to 500 nm; and/or
at least 1 nm, 50 nm, 100 nm, 200 nm, 300 nm, 400 nm, 500 nm, 600 nm, 700 nm, 800 nm, 900 nm and 1000 nm; and/or
less than 1000 nm, 900 nm, 800 nm, 700 nm, 600 nm, 500 nm, 400 m, 300 nm, 200 nm, 100 nm, 50 nm, 25 nm, or 5 nm, or 1 nm.

In one embodiment the average diameter of the dielectric core when coated in a 10 nm layer of chromium or other metal used for imaging purposes such as gold or other conductive material is:
from 1 nm to 1000 nm, optionally from 50 nm to 900 nm; 100 nm to 800 nm; 200 nm to 700 nm; 300 nm to 600 nm, 400 to 500 nm; and/or
at least 1 nm, 50 nm, 100 nm, 200 nm, 300 nm, 400 nm, 500 nm, 600 nm, 700 nm, 800 nm, 900 nm and 1000 nm; and/or
less than 1000 nm, 900 nm, 800 nm, 700 nm, 600 nm, 500 nm, 400 m, 300 nm, 200 nm, 100 nm, 50 nm, 25 nm, or 5 nm, or 1 nm,
as determined by electron microscopy.

In some embodiments the average diameter of each metallic material-coated nanostructure of the plurality of nanostructures is:
from 1 nm to 1000 nm, optionally from 50 nm to 900 nm; 100 nm to 800 nm; 200 nm to 700 nm; 300 nm to 600 nm, 400 to 500 nm; and/or
at least 1 nm, 50 nm, 100 nm, 200 nm, 300 nm, 400 nm, 500 nm, 600 nm, 700 nm, 800 nm, 900 nm and 1000 nm; and/or
less than 1000 nm, 900 nm, 800 nm, 700 nm, 600 nm, 500 nm, 400 m, 300 nm, 200 nm, 100 nm, 50 nm, 25 nm, or 5 nm, or 1 nm.

In some embodiments the average diameter of each metallic material-coated nanostructure of the plurality of nanostructures, when coated in a 10 nm layer of chromium or other metal used for imaging purposes such as gold or other conductive material, is:
from 1 nm to 1000 nm, optionally from 50 nm to 900 nm; 100 nm to 800 nm; 200 nm to 700 nm; 300 nm to 600 nm, 400 to 500 nm; and/or
at least 1 nm, 50 nm, 100 nm, 200 nm, 300 nm, 400 nm, 500 nm, 600 nm, 700 nm, 800 nm, 900 nm and 1000 nm; and/or
less than 1000 nm, 900 nm, 800 nm, 700 nm, 600 nm, 500 nm, 400 m, 300 nm, 200 nm, 100 nm, 50 nm, 25 nm, or 5 nm, or nm,
when the diameter is determined by electron microscopy.

In some embodiments the dielectric core is greater than 252 nm (or is greater than 252 nm when coated in a 10 nm layer of chromium or other metal used for imaging purposes such as gold or other conductive material). The skilled person will appreciate that the diameter of the dielectric core particles quoted by manufacturers of such particles may not be the true diameter, and some error in measurement is to be expected. Accordingly, dielectric core particles that are stated to have a diameter of 252 nm by manufacturers, may actually have a diameter of only 198+/−9 nm when measured using SEM (coated with Cr for imaging).

Accordingly in some embodiments the dielectric core has a diameter of 190 nm or greater, for example at least 190 nm, 198 nm, 200 nm, 210 nm, 220 nm, 230, 240, 250, 252, 260, 270, 280, 290, 300 nm for example.

In some embodiments where the metallic material is a single layer of copper, the dielectric core is not 130 nm, 355 nm, 462 nm, or 534 nm in diameter, or is not is not 130 nm, 355 nm, 462 nm, or 534 nm in diameter when coated in a 10 nm chromium or other metal used for imaging purposes such as gold or other conductive material layer for the purpose of electron microscopy.

In some embodiments the dielectric core is greater than 190 nm, 198 nm, 252 nm, (or greater than 190 nm, 198 nm, 252 nm when coated in a 10 nm layer of chromium or other metal used for imaging purposes such as gold or other conductive material for microscopy purposes) and when the metallic material is copper the dielectric core is not 130 nm, 355 nm, 462 nm, or 534 nm in diameter (or is not is not 130 nm, 355 nm, 462 nm, or 534 nm in diameter when coated in a 10 nm layer of chromium or other metal used for imaging purposes such as gold or other conductive material for microscopy purposes).

The thickness of the metallic coating can be any thickness, providing it maintains the capped structure and does not result in a continuous layer of metallic material across the dielectric cores. It is considered that altering the thickness of the metallic material has an effect on the plasmonic response of the chip, and so optimising the thickness of the metallic coating can be used to impart particular properties to the chip. Altering the thickness of the coating typically results in a red shift or a blue shift of the spectrum, whilst maintaining the multiple peak property of the chip.

In some embodiments the metal coating has an average maximum average thickness of from 1 nm to 1000 nm. In some embodiments the metal coating has an average maximum thickness of:
at least 1 nm, 2, 3, 4, 5, 6, 7, 8, 9, 10, 11, 12, 13, 14, 15, 20, 30, 40, 50, 60, 70, 80, 90, 100, 150, 200, 250, 300, 350, 400, 450, 500, 550, 600, 650, 700, 750, 800, 850, 900, 950 or at least 1000 nm; and/or
less than 1000 nm, 950, 900, 850, 800, 750, 700, 650, 600, 550, 500, 450, 400, 350, 300, 250, 200, 150, 100, 90, 80, 70, 60, 50, 40, 30, 20, 15, 14, 13, 12, 11, 10, 9, 8, 7, 6, 5, 4, 3, 2 or 1 nm; and/or
from 1 nm to 1000 nm, 2 to 950, 3 to 900, 4 to 850, 5 to 800, 6 to 750, 7 to 700, 8 to 650, 9 to 600, 10 to 550, 11 to 500, 12 to 450, 13 to 400, 14 to 350, 15 to 300, 20 to 250, 30 to 200, 40 to 150, 50 to 100, 60 to 90, 70 to 80 nm.

The shape of the nanostructures is also considered to impact the properties of the chip, and again can be tuned to impart the desired properties on the chip, i.e. LSPR at the required wavelengths.

In some embodiments the nanostructures have a shape selected from the group comprising or consisting: spherical, substantially spherical, elliptical, star-shaped, ovoid, pyramidal, cube, cuboid and optionally any combination thereof. For example, star-shaped nanostructures can be formed by etching the dielectric particles into start-shaped dielectric core particles prior to metallic coating, for example by sputtering.

By substantially spherical we include the meaning of essentially as spherical as it is possible to obtain via RIE. In some instances etching via RIE leads to dielectric core particles that have variation between the horizontal and vertical diameter of the substantially spherical shape, for example in some embodiments the shape is elliptical.

In preferred embodiments the nanostructures are spherical or are substantially spherical (the skilled person will understand that depending on the method of fabrication, achieving perfect spheres may be difficult, and unnecessary).

In other preferred embodiments the nanostructures are star-shaped.

As discussed above, the distance between the nanostructures can be any appropriate distance, but preferably the distance between nanostructures within a given region of the chip is the same, and the nanostructures are arranged in a regular array, for example in a hcp format.

In some embodiments the average distance between the outermost metal-coated surfaces of any two adjacent nanostructures of the plurality of nanostructures is from 1 nm and 500 nm. For example, in some embodiments the average distance between the outermost metal-coated surfaces of any two adjacent nanostructures of the plurality of nanostructures, when also coated in a 10 nm thick layer of chromium or other metal used for imaging purposes such as gold or other conductive material for visualisation purposes, is from 1 nm and 500 nm. The distance between the outer surface of adjacent nanostructures can be determined by various methods known to the skilled person, including SEM.

In some embodiments the average distance between the outermost metal-coated surfaces of any two adjacent nanostructures of the plurality of nanostructures is: at least 1 nm, optionally at least 5 nm, 10, 15, 20, 25, 30, 35, 40, 45, 50, 60, 70, 80, 90, 100, 125, 150, 175, 200, 225, 250, 275, 300, 325, 350, 375, 400, 425, 450, 475 or at least 500 nm; and/or
less than 500 nm, optionally 475, 450, 425, 400, 375, 350, 325, 300, 275, 250, 225, 200, 175, 150, 125, 100, 90, 80, 70, 60, 50, 40, 30, 20, 15, 10, or less than 5 nm; and or
from 1 nm to 500 nm, optionally 5 nm to 475 nm, 10 nm to 450 nm, 15 nm to 425 nm, 20 nm to 400 nm, 25 nm to 375 nm, 30 nm to 350 nm, 35 nm to 325 nm, 40 nm to 300 nm, 45 nm to 275 nm, 50 nm to 250 nm, 60 nm to 225 nm, 70 nm to 200 nm, 80 nm to 175 nm, 90 nm to 150 nm, 100 nm to 125 nm.

In some embodiments the average distance between the outermost metal-coated surfaces of any two adjacent nanostructures of the plurality of nanostructures when also coated in a 10 nm layer of chromium or other metal used for imaging purposes such as gold or other conductive material for visualisation purposes is: at least 1 nm, optionally at least 5 nm, 10, 15, 20, 25, 30, 35, 40, 45, 50, 60, 70, 80, 90, 100, 125, 150, 175, 200, 225, 250, 275, 300, 325, 350, 375, 400, 425, 450, 475 or at least 500 nm; and/or
less than 500 nm, optionally 475, 450, 425, 400, 375, 350, 325, 300, 275, 250, 225, 200, 175, 150, 125, 100, 90, 80, 70, 60, 50, 40, 30, 20, 15, 10, or less than 5 nm; and or
from 1 nm to 500 nm, optionally 5 nm to 475 nm, 10 nm to 450 nm, 15 nm to 425 nm, 20 nm to 400 nm, 25 nm to 375 nm, 30 nm to 350 nm, 35 nm to 325 nm, 40 nm to 300 nm, 45 nm to 275 nm, 50 nm to 250 nm, 60 nm to 225 nm, 70 nm to 200 nm, 80 nm to 175 nm, 90 nm to 150 nm, 100 nm to 125 nm.

As described above, in some instances the arrangement of the nanoparticles on the chip is random. In some embodiments then the distance between the outermost metal-coated surface of at least one nanostructure and the outermost metal-coated surface of least one other adjacent nanostructure is different to the distance between the outermost metal-coated surface of at least a second nanostructure and the outermost metal-coated surface of least one other adjacent nanostructure.

It is also the case that different regions on the chip may have a different arrangement of nanostructures (either the same or different nanostructures). Accordingly in some embodiments the distance between the outermost metal-coated surface of the nanostructures in a first region of the chip is different to the distance between the outermost metal-coated surface of the nanostructures in a second region of the chip. In some embodiments the nanostructures are the same and have the same properties and features. In other embodiments the properties and features of the nanostructures differ between the first and second regions.

In some embodiments all of the nanoparticles on the surface of the substrate are largely identical (i.e. identical as far as it is physically possible to make identical nanoparticles), i.e. same sized dielectric core, same material of dielectric core, same metallic coating, same thickness of metallic coating, and are regularly spaced—as far as it is practicable to achieve this. Examples of such identical nanoparticles arranged regularly on the surface of a chip are described in the Examples and shown in the Figures—i.e. arrays produced according to the methods described in the examples are considered to result in a chip that comprises a number of identical nanoparticles regularly arrayed on the surface of the chip.

As mentioned above, the chip comprises a substrate to which the nanostructures are bound. The substrate could be any substrate, but preferably the substrate is a solid substrate, which allows the particular arrangement of the nanostructures on the surface since it is considered that the arrangement of the nanostructures impacts the properties of the chip.

In some embodiments the substrate takes the form of a bead, which can be coated with the nanostructures and can be used in fluidic methods. In this embodiment the term chip is considered to encompass such a coated bead.

As mentioned above, the substrate may have a metal coating or film, for example deposited as part of the metal capping process.

It will be appreciated to the skilled person that any of the metal surface of the chip may contain some level of oxidation and so may comprise an oxide layer Accordingly, in one embodiment the substrate is a solid substrate.

The substrate may be transparent, translucent, or opaque. Preferably the substrate is an inert substrate without any optical interference with metallic nanostructures. In a preferred embodiment the substrate is transparent. In some embodiments the substrate comprises or consists of a material selected from the group comprising or consisting: glass, metal, plastic, agar or agarose, or any combination thereof.

In some embodiments the substrate has been treated. The skilled person will be aware of suitable treatments and processes that are appropriate for the substrate, for example prior to arrangement of the dielectric particles on the surface. In some embodiments the substrate has been treated using a method selected from the group comprising or consisting: degreasing, etching, acid washing, flaming, or any combination thereof.

In some instances, the treatment results in surface modification of the substrate, for example wherein the surface of the substrate has been functionalised, optionally wherein a thiol or amine surface is formed.

In some instances, said treatment can comprise the application of an adhesive layer. Accordingly in some embodiments the chip of the invention comprises an adhesive layer between the substrate and the nanostructures and/or between the substrate and a metal layer that in some preferred embodiments is located across the substrate following metal deposition on the dielectric cores.

The adhesive layer can be a chemical adhesion layer such as MPTES, or can be a thin metal adhesion layer, such as a thin layer of Cr.

It is considered that an adhesion layer would improve the stability of the metallic layer/film that is on the substrate in some embodiments, and resistance when incorporated into assays (for example washing steps, which require strong glass/metal adhesion).

The particular features of the chip, i.e. the presence of the nanostructures and described materials results in the formation of a surface plasmon within a portion of the chip. Accordingly when the chips of the invention are exposed to light of a particular wavelength or wavelengths, a surface plasmon forms on a portion of the chip.

It is considered that the ability of the chips of the invention to enhance the fluorescence of multiple fluorophores in different spectral regions is at least partly due to the formation of different LSPRs in different sublocations of the chip, for example between the interface of the metallic cap and the substrate; and/or between nanostructures etc. It is also considered that there are hybrid modes of LSPR formation. In one embodiment the surface plasmon forms on the surface of the metallic material that coats the nanostructure. Determining the formation of a plasmonic peak is routine for the skilled person in this field.

The light that induces one or more surface plasmons is in some embodiments selected from the group comprising or consisting: ultraviolet (UV) light, visible light, near-infra-red (NIR) light, and NIR-II light, or any combination thereof, optionally wherein UV light has a wavelength of between 100-400; visible light has a wavelength of between 380-700; NIR I has a wavelength of between 650-900; and NIR II has a wavelength of between 1000-1400. Multiple wavelengths of light can be used to stimulate the formation of different plasmons in the different spectral regions, and so can be used to simultaneously enhance the fluorescence from a range of fluorophores.

For example, in one embodiment exposure of the chip to light from at least two different spectral regions induces the formation of a surface plasmon within a portion of the chip, optionally wherein the spectral regions are selected from the group comprising or consisting of: ultraviolet (UV) light, visible light, near-infra-red (NIR) light, and NIR-II light, or any combination thereof, optionally wherein UV spectral region has a wavelength of between 100-400; the visible spectral region has a wavelength of between 380-700; NIR I spectral region has a wavelength of between 650-900; and NIR II spectral region has a wavelength of between 1000-1400.

It is also clear that excitation of multiple fluorophore from different spectral regions can be achieved using the same wavelength or same range of wavelengths of light. The skilled person will appreciate that this depends on the absorption/emissions of the fluorophores.

Multiple plasmons may be stimulated within the same portion of the chip—i.e. within an area of the chip where the nanostructures are all the same and have the same spatial arrangement.

To be clear, it is not considered necessary to modify the physical features of the nanostructures to obtain a chip capable of forming multiple plasmons. A single chip can comprise a single type of nanostructure (i.e. same dielectric core, same metallic material, same thickness of metallic coating, same size particle, and all similarly spaced) and still produce multiple plasmons in different spectral regions—one reason for this may be that the particular features of the claimed chip allows the formation of different plasmons between different sublocations, for example between nanostructures, between the edge of the cap and the substrate etc.

In some embodiments the excitation light used to induce the plasmons has a wavelength of:
from 10 nm to 1400 nm, for example from 10 nm to 400 nm, 400 nm to 700 nm, 700 nm to 1000 nm, and 1000 nm to 1400 nm; and/or at least 10 nm, 400 nm, 700 nm, 1000 nm, or 1400 nm; and/or
less than 1400 nm, 1000, 700, 400, or less than 10 nm.

In preferred embodiments the light has a wavelength of between 350 nm and 1400 nm.

The skilled person will appreciate that fluorophores are excited with a range of wavelengths, each having a peak or max excitation wavelength. This is the wavelength that is typically used to excite a given fluorophore. Filters can be used so that the fluorophore is exposed to only one particular wavelength. For multiplex methods multiple filters can be used so that multiple particular wavelengths are let through to the chip. The skilled person will understand that in some instances it is preferable if the light being used to excite one fluorophore does not overlap with the excitation spectra of another fluorophore that is being used in the same experiment.

The skilled person will understand that any wavelength of light can be used, for example if the chip shows an extinction peak in a lower or higher range and there is overlap then you can change the fluorophore. Changing the morphology and features of the chip changes the “peak” plasmon position and can change which fluorophore is most suitable to use with that chip. Conversely, if using a particular fluorophore is desired, the morphology and features of the chip can be modified so that the peak plasmon matches the peak excitation of the fluorophore. The skilled person is aware of a very large number of commercially available fluorophores. The present invention is considered to be suitable for use with any fluorophore.

The chips of the invention are capable of enhancing the fluorescence of at least one fluorophore, preferably at least 2, 3, 4, 5, 6, 7, 8, 9 or at least 10 fluorophores. Enhancement of fluorescence by the chip is considered relative to the intensity of fluorescence observed in the absence of the chip, or in the presence of the chip that lacks the metal caps, i.e. a chip coated in dielectric cores, but without the metallic caps. In some embodiments:
the fluorescence of at least one fluorophore, preferably at least 2, 3, 4, 5, 6, 7, 8, 9 or at least 10 fluorophores is enhanced by at least 20%, 25%, 30%, 35%, 40%, 45%, 50%, 100%, 150%, 200%, 250%, 300%, 350%, 400%, 450%, 500%, 550%, 600%, 650%, 700%, 750%, 800% times, optionally where the fluorescence of each fluorophore is capable of being enhanced simultaneously.

In some embodiments:
the sensitivity of the detection of at least one fluorophore is enhanced, preferably the sensitivity of the detection of at least 2, 3, 4, 5, 6, 7, 8, 9 or at least 10 fluorophores is enhanced, for example is enhanced by at least 20%, 25%, 30%, 35%, 40%, 45%, 50%, 100%, 150%, 200%, 250%, 300%, 350%, 400%, 450%, 500%, 550%, 600%, 650%, 700%, 750%, 800% times, optionally where the fluorescence of each fluorophore is capable of being enhanced simultaneously.

It will be clear to the skilled person, and as described herein, that the chips of the present invention are particularly useful for enhancing the fluorescence in methods of bio detection or environmental sensing. Chip based ELISA methods to detect particular proteins or peptides or fragments thereof or microarray methods that detect particular nucleic acids are known to the skilled person. The skilled person is aware that typically a capture agent is used that has a specific binding affinity for the target. For example, the capture agent may be an antibody that binds to a particular target antigen.

In some embodiments, the chip comprises a capture agent which is bound to the chip. The agent may be bound to the underlying substrate, and/or may be bound to the metal coating/film that is typically found coating the substrate, and/or may be found on the nanostructures. Typically the agent will be bound to the chip once the metallic cap has been applied to the dielectric core, in which case the agent will typically be located on all surfaces.

In some embodiments, the capture agent is a protein. In some embodiments the protein is selected from the group comprising or consisting: an antibody or antigen binding fragment thereof, actin, albumin, casein, collagen, dystrophin, fibrinogen, fibronectin, flagellin, gelatin, keratin, α-lactalbumin, β-lactalbumin, lactoferrin, myosin, titin, tubulin, or any combination thereof.

The skilled person will appreciate that there are numerous antibody formats and antigen-binding fragments that would be suitable for localising to the chip and that are suitable for specifically binding to a target analyte. For example in some embodiments the antibody or antigen binding fragment thereof is selected from the group comprising or consisting: IgA, IgD, IgE, IgM, IgG, IgY, IgW, Fab, F(ab′)₂, monospecific Fab₂, bispecific Fab₂, Trispecific Fab₃, monovalent IgG, scFv, diabody, bispecific diabody, triabody, trispecific triabody, tetrabody, scFv-sc, minibody, nanobody, IgNAR, V-NAR, hcIgG, VhH, Vh, or any combination thereof.

Nucleic acids are also capable of specifically binding to a target analyte. Accordingly in some embodiments the capture agent is a nucleic acid. In some embodiments the nucleic acid is DNA, for example may be is selected from the group comprising or consisting: cccDNA, ccfDNA, cDNA, cfDNA, cffDNA, circular DNA, cpDNA, ctDNA, dsDNA, eccDNA, ecDNA, eDNA, exogenous DNA, gDNA, i-DNA, linker DNA, microDNA, mtDNA, msDNA, ncDNA, rDNA, ssDNA, or any combination thereof.

In other embodiments the nucleic acid is RNA, for example is selected from the group comprising or consisting: 7SK RNA, asRNA, cfRNA, circRNA, crRNA, diRNA, dsRNA, eRNA, exRNA, gRNA, lncRNA, miRNA, natsiRNA, ncRNA, piRNA, pre-mRNA, rasiRNA, RNase MRP, RNase P, rRNA, scaRNA, sgRNA, shRNA, siRNA, SL RNA, SmY RNA, snRNA, snoRNA, ssRNA, tasiRNA, telomerase RNA, tmRNA, tRNA, tracrRNA, Y RNA, or any combination thereof.

The capture agent comprises a region that is capable of binding specifically to the target analyte. The skilled person in the field will understand what is meant by specifically binding. Briefly specifically binding means that the capture agent has a higher affinity for the target analyte than for any other analyte that is expected to be in the sample. For examples antibodies typically have a high affinity towards a single antigen and are routinely used in analyte detection and isolation.

In some instances the target analyte may be directly conjugated to a fluorophore. For example during some PCR based methods, fluorophores can be incorporated into the amplicons. In other examples proteins tagged with fluorescence labels may be expressed by a particular cell (for example microbial or mammalian cell) or tissue. Contact between a fluorophore labelled analyte and the capture agent of the chip localises the target analyte and fluorophore to the surface of the chip. This brings the fluorophore into close proximity with the surface of the chip. Exposure to light of the correct wavelength will generate the appropriate LSPR which in turn will enhance the fluorescence from the fluorophore. Since the chip of the invention is capable of producing multiple LSPRs in different spectral regions, it is possible for the chip to pull-down more than one target analyte each labelled with a different fluorophore, and simultaneously stimulate the fluorescence from each label. This allows the multiplex detection of multiple different analytes from a particular sample, or for example the same analyte from multiple different samples, each labelled with a different fluorophore.

In other instances it is not appropriate for the target analyte to be directly conjugated to a fluorophore, for example if the aim of the sensing is to detect the presence of multiple proteins in a sample obtained from a subject. In this case, a second binding agent, a detection agent, can be used. The detection agent is also capable of binding specifically to the target analyte. In some instances the capture agent and the detection agent are the same, for example are the same antibody. In other instances, the capture agent and the detection agent are different.

The detection agent is labelled with a fluorophore, for example is a fluorophore labelled antibody. The chip (comprising the capture agent) is exposed to the sample so as to allow the target analyte (if present) to bind to the surface of the chip via the capture agent. The chip/target analyte is then exposed to the detection antibody, which binds to the target analyte which is itself bound to the capture agent. This brings the fluorophore label present on the detection agent into proximity with the surface of the chip and the LSPRs, when stimulated.

The second agent may be an antibody or antigen binding fragment thereof, for example may be selected from the group comprising or consisting: IgA, IgD, IgE, IgM, IgG, IgY, IgW, Fab, F(ab′)₂, monospecific Fab₂, bispecific Fab₂, Trispecific Fab₃, monovalent IgG, scFv, diabody, bispecific diabody, triabody, trispecific triabody, tetrabody, scFv-sc, minibody, nanobody, IgNAR, V-NAR, hcIgG, VhH, Vh, or any combination thereof.

Preferably the second agent, antibody or antigen binding fragment thereof is conjugated to a fluorophore.

The fluorophores that are suitable for use with the chip of the invention, and which may be used to label the detection agent or target analyte may be any fluorophore.

In some embodiments the fluorophore is a fluorescent protein or luminescent protein. For example the fluorescent protein or luminescent protein may be selected from the group comprising or consisting: aequorin, Allophycocyanin, AmCyan1, AsRed2, Azami Green, Azurite, B-phycoerythrin, CyPet, DsRed, DsRed2, GFP, GFPuv, EBFP, EBFP2, ECFP, EGFP, Emerald, EYFP, HcRed1, horseradish peroxidase, J-Red, Katusha, Kusabira Orange, luciferase, mCardinal, mCFP, mCherry, mCitrine, mEmerald, Midoriishi Cyan, mKate, mKeima-Red, mKO, mNeonGreen, mOrange, mPlum, mRaspberry, mRFP1, mStrawberry, mTFP1, mTurqoise2, P3, PerCP, R-phcoerythrin, RFP, T-Sapphire, TagCFP, TagGFP, TagRFP, TagYFP, tdTomato, Topaz, TurboFP602, TurboFP635, TurboGFP, TurboRFP, TurboYFP, Venus, YFP, YPet, ZsGreen1, or any combination thereof.

In some embodiments the fluorophore is a fluorescent or luminescent dye, for example in some embodiments the fluorescent or luminescent dye is selected from the non-limiting group comprising or consisting: 7-AAD, Abberior Dyes, acridine, acridine orange, acridine yellow, AlexaFluor, aminocourmarin, anthracene, anthraquinone, APC, APC-Cy7, APCXL, arylmethine, Atto, auramine, aza-BODIPY, Bella Fluor, benzoxadiazole, bilirubin, BODIPY, BODIPY-FL, BPE, Cal Fluor, cascade blue, CF dye, Chromomycin A3, coumarin, crystal violet, cresyl violet, Cy2, Cy3, Cy3B, Cy3.5, Cy5, Cy5.5, Cy7, cyanine, CyTRAK, CAPI, dipyrromethene, DCFH, DHR, DRAQ, DRAQ5, DRAQ7, DYDye, DyLight Fluor, eosin, ethidium bromide, EverFluor, Fluo-3, Fluo-4, fluorescein, FluoroProbes, FluorX, G-Dye100, G-Dye200, G-Dye300, G-Dye400, HiLyte Fluor, hoechst, hydroxycourmarin, Indo-1, indocarbocyanine, LDS 751, lissamine rhodamine B, lucifer yellow, malachite green, MegaStokes Dye, merocyanine, methoxycourmarin, Mithramycin, naphthalene, NBD, Nile blue, Nile red, nitrobenzoxadiazole, Oregon green, oxadiazole, oxacarbocyanine, oxazine, oxazine 170, pacific blue, pacific orange, PE-Cy5, PE-Cy7, perCP, phthalocyanine, porphin, proflavin, propidium iodide, rhodamine, pyrene, pyridyloxazole, Quasar Fluor, Red 613, RPE, R-Phycoerythrin, Seta Dye, SeTau Dye, SNARF, Square Dye, squarine, squarine rotaxane, Sulfo Cy dye, SureLight Dye, SYTOX blue, SYTOX green, SYTOX orange, Tau dyes, tetrapyrrole, Texas red, thiacarbocyanine, thiazole orange, TO-PRO-1, TO-PRO-3, TOTO-1, TOTO-3, Tracy, TRITC, TruRed, Vio Dye, xanthene, X-rhodamine, YOYO-1, or any combination thereof.

In some embodiments the fluorescent or luminescent dye is light emitting material, for example quantum dots.

In preferred embodiments the chip enhances the fluorescence of at least two or more, for example at least 3, 4, 5, 6, 7, 8, 9 or at least 10 fluorophores simultaneously. For example in some embodiments the chip enhances the fluorescence of the following fluorophores: Alexa Fluor 405, Alexa Fluor 530, Alexa Fluor 555, Alexa Fluor 647, Alexa Fluor 790 and IR-E1050, optionally wherein the chip is capable of enhancing the fluorescence from each of Alexa Fluor 405, Alexa Fluor 530, Alexa Fluor 555, Alexa Fluor 647, Alexa Fluor 790 and IR-E1050 simultaneously.

In some instances the nanostructures are in direct contact with the substrate. However in some embodiments the nanostructures are not in direct contact with the substrate, for example in some embodiments the nanostructures are positioned on nano pillars and wherein the nano pillars are in contact with the substrate, optionally wherein the nanopillars are made from glass.

In some embodiments the chip is a chip that has been produced by a method that involves etching of a dielectric core and subsequent spluttering of a metallic material to form a cap structure on the dielectric core. In some embodiments the chip is a chip that has been produced by any of the methods described herein.

In addition to providing the chip that comprises the nanostructures, the invention also provides the nanostructures per se. Preferences for the nanostructures are as described above. The invention also provides a composition comprising the nanostructures of the invention.

The invention also provides various methods and uses of using the chips of the invention, including in medical diagnostics and environmental sensing.

In one embodiment the invention provides a method of enhancing the fluorescence intensity of light emitted by at least one fluorophore using the chip of the invention, wherein said at least one fluorophore has an excitation wavelength and an emission wavelength.

The invention also provides a method of plasmon enhanced fluorescence of at least one fluorophore using the chip of the invention, wherein said at least one fluorophore has an excitation wavelength and an emission wavelength.

The invention also provides a method of metal enhanced fluorescence of at least one fluorophore using the chip of the invention, wherein said at least one fluorophore has an excitation wavelength and an emission wavelength.

It will be appreciated that herein the terms enhancing the fluorescence, plasmon enhanced fluorescence and metal enhanced fluorescence are used interchangeably, and the terms describe the method of enhancement.

Preferences for the features of the methods, for example the features of the chip, the fluorophore, and the features of excitation wavelength etc are as described herein.

In some embodiments the excitation wavelength is selected from the group comprising or consisting: ultraviolet (UV) light, visible light, near-infra-red (NIR) light, and NIR-II light, or any combination thereof, optionally wherein UV light has a wavelength of between 100-400; visible light has a wavelength of between 380-700; NIR I has a wavelength of between 650-900; and NIR II has a wavelength of between 1000-1700. Although the chips of the invention are suitable for use in enhancing the emission from a single fluorophore, they are capable of enhancing fluorescence from a range of fluorophores across a range of a spectral regions. The advantages here are numerous. In one instance it is possible to enhance the fluorescence of a range of fluorophores simultaneously. In another instance, since a single chip can be used to enhance the fluorescence of a range of fluorophores across a range of spectral regions, a single fabrication can be used to make multiple identical chips but which can be used for different fluorophores. In this way the fabrication process is much simpler and the chips can be produced at scale, but be used for different fluorophores. Accordingly, the advantages of the present invention are not only apparent when the multiple fluorophores are assayed simultaneously, but the potential to assay any of a wide range of fluorophores on a single chip is a distinct advantage.

Current chips are not capable of enhancing the fluorescence of more than 1, for example 2, 3, 4, 5, 6, 7, 8, 9 or 10 fluorophores, particularly fluorophores that have excitation wavelengths in different spectral regions. Accordingly current chips do not provide the user with a choice of fluorophores even in situations where only one fluorophore is required.

Accordingly the invention also provides a method of metal enhanced fluorescence; a method of plasmon enhanced fluorescence; and/or a method of enhancing the fluorescence signal emitted by a fluorophore using the chip of the invention, wherein the chip is capable of enhancing fluorescence of at least one fluorophore, optionally at least 2, 3, 4, 5, 6, 7, 8, 9, or at least 10 or more fluorophores, optionally wherein the fluorophores are from different spectral regions, wherein the method comprises bringing a single fluorophore into proximity with the chip so as to allow MEF to occur, wherein the fluorophore is selected from the more than one fluorophores.

The invention also provides a method of metal enhanced fluorescence; a method of plasmon enhanced fluorescence; and/or a method of enhancing the fluorescence signal emitted by a fluorophore using the chip of the invention, wherein the chip is capable of enhancing fluorescence of more than one fluorophore, optionally at least 2, 3, 4, 5, 6, 7, 8, 9 10 or more fluorophores, optionally wherein the fluorophores are from different spectral regions, wherein the method comprises bringing multiple different fluorophores into proximity with the chip so as to allow MEF to occur, wherein the fluorophore is selected from the more than one fluorophores and optionally wherein at least two of the fluorophores have a max excitation wavelength from different spectral regions.

In some embodiments of the methods of the invention, the method comprises enhancing the fluorescence intensity of light emitted by more than one fluorophore.

In some embodiments, the method comprises enhancing the fluorescence intensity of light emitted by at least two, at least three, at least four, at least five, or at least six different fluorophores.

In some embodiments of the methods, at least one fluorophore has a different maximum excitation wavelength and/or a different maximum emission wavelength than any other fluorophore.

In some embodiments of the methods, at least one fluorophore has an excitation wavelength in a different spectral region to another fluorophore, optionally wherein the spectral regions are UV, visible, NIR I and NIR II; optionally wherein the:
UV spectral region has a wavelength of between 100-400;
visible spectral region has a wavelength of between 380-700;
NIR I spectral region has a wavelength of between 650-900; and
NIR II spectral region has a wavelength of between 1000-1400.

As will be understood by the skilled person, the mechanism by which the fluorescence is enhanced is through metal enhanced fluorescence (MEF).

It will be apparent to the skilled person that the fluorescence intensity of light emitted by a fluorophore is considered enhanced if there is an increase in the intensity of said fluorophore in the presence of the chip compared to in the absence of the chip. For example, in instances where the chip forms part of the inner surface of a well in a multi-well plate, the chip enhances the intensity of light emitted by a fluorophore if the intensity of light from the fluorophore in a well that comprises the chip of the invention is higher than the intensity of light from the fluorophore in a well that does not comprise the chip of the invention.

The skilled person will understand the necessary statistical methods and controls so as to confirm that a given chip of the invention does increase the intensity of the emitted signal.

An increase may be any increase, for example may be a 1%, 2%, 5%, 10%, 15%, 20%, 25%, 30%, 40%, 50%, 60%, 70%, 80%, 90%, 100%, 150%, 200%, 250%, 300%, 350%, 400%, 450% or at least a 500% increase in intensity.

In some embodiments the fluorescence intensity is considered to be enhanced if there is an increase in the fluorescence in the presence of the chip of the invention relative to the fluorescence obtained using a chip of the invention which does not comprise the metallic caps, i.e. a chip comprising an array of dielectric cores which does not comprise a metallic cap.

In some embodiments of the methods of the invention, the method comprises the steps of:
(1) exposing the chip to light with a wavelength (λ_{Ex}) capable of exciting at least one of the fluorophores,
(2) measuring the fluorescence intensity of the emitted light λ_{Em}; and optionally
(3) correlating the presence or intensity of the emitted light of λ_{Em} with the presence, absence or amount of a target analyte.

In some embodiments, the methods of the invention are for the detection of a target analyte. As described above, the target analyte may be bound to the chip via a surface immobilised capture agent. The target analyte itself may be labelled with one or more fluorophores, or, the fluorophore may be conjugated to a detection agent which binds to the target analyte. Preferences for features of this embodiment, for example the capture agent and detection agent are as described elsewhere herein.

Such methods are referred to as ELISA methods and are well known in the field. Accordingly in some embodiments the method of detecting a target analyte is an ELISA method. In some embodiments the ELISA method is selected from the group comprising or consisting: direct ELISA, indirect ELISA, sandwich ELISA, competitive ELISA, or any combination thereof. In some preferred embodiments the ELISA method is a fluorescent ELISA method.

The chips and methods of the invention are also suitable for use with microarray based assays. In one embodiment then the methods of the invention involve the use of a microarray.

Any of the methods may comprise an additional step in which the presence of or intensity of the emitted light from the or each fluorophore is determined and correlated with correlated with the presence or amount of a target analyte. Detection and quantification of emitted fluorescence is routine. Accordingly in some embodiments the methods determine the presence of or amount of a target analyte or more than one target analyte.

The target analyte may potentially be present in any type of sample. For example the sample may be a biological sample, such as a biological sample selected from the group comprising or consisting: amniotic fluid, bile, blood, bone, bone marrow, cells, faeces, lymph, mucous, plasma, saliva, semen, sebum, sputum, sweat, tears, tissue or any combination thereof. In particular embodiments the biological sample is saliva, sputum or blood. Biological samples are typically very complex and comprise a number of different agents that are capable of inhibiting or otherwise disturbing the normal excitation or emission of a fluorophore. For example blood is known to absorb particular wavelengths making detection of target analytes in samples comprising blood difficult. Since the present invention allows the enhancement of fluoresce of fluorophores across different spectral regions, appropriate fluorophores can be used. Furthermore, since the fluorescence is enhanced in many instances the emitted light is detectable even in such complex samples.

The biological sample may be a biopsy.

The biological sample may be processed or not processed prior to use with any of the methods and chips of the invention. For example the sample may be a cell lysate.

In other embodiments the sample is an environmental sample, for example is a swab taken from a surface. Such samples are analysed for the presence of pathogens, such as Salmonella. Similar sample types can be used to detect the presence of illegal drugs or explosives.

In some embodiments, the target analyte is associated with an organism or a virus. In some embodiments the organism or virus is a pathogen, for example a pathogen found in a biological sample or in an environmental sample. For example the target analyte may be a protein or fragment thereof, or nucleic acid, that is associated with and indicative of the presence of, a pathogen. The pathogen may be any time of pathogen, including those detailed below.

In some embodiments the pathogen is selected from the group comprising or consisting: a bacterium, a eukaryote, or a virus.

In some embodiments the bacterium is a bacterium of a genus selected from the group comprising or consisting: Aeromonas, Actinomyces, Bacillus, Bacteroides, Bartonella, Bordetella, Borrelia, Brucella, Burkholderia, Campylobacter, Chlamydia, Chlamydophila, Citrobacter, Clostridium, Corynebacterium, Ehrlichia, Enterobacter, Enterococcus, Escherichia, Francisella, Haemophilus, Helicobacter, Klebsiella, Legionella, Leptospira, Listeria, Mycobacterium, Mycoplasma, Neisseria, Nocardia, Pseudomonas, Rickettsia, Salmonella, Serratia, Shigella, Staphylococcus, Streptococcus, Treponema, Ureaplasma, Vibrio, or Yersinia.

In other embodiments the eukaryote is a fungus, optionally wherein the fungus is a fungus of a genus selected from the group comprising or consisting: Aspergillus, Blastomyces, Candida, Coccidioides, Cryptococcus, Histoplasma, Paracoccidioides, Pneumocystis, Sporothrix, Stachybotrys, and Taloromyces.

In some embodiments the eukaryote is a protozoan, optionally wherein the protozoan is a protozoan of a genus selected from the group comprising or consisting: Acanthamoeba, Babesia, Balantidium, Cryptosporidium, Cyclospora, Dientamoeba, Entamoeba, Giardia, Leishmania, Plasmodium, Toxoplasma, Trichomonas, or Trypanosoma.

In some embodiments the eukaryote is a parasitic worm, optionally wherein the parasitic worm is selected from the group comprising or consisting: roundworm, flatworm, whipworm, pinworm, tapeworm.

In some embodiments the pathogen is a virus, for example is a virus selected from the group comprising or consisting: Coronavirus (CoV), Adenovirus, Bannavirus, BK Virus, Cocksackievirus, Coltivirus, Crimean-Congo Haemorrhagic Fever Virus, Dengue Virus, Ebola Virus (EV), Epstein-Barr virus, Hanta virus, Hantaan Virus, Hepatitis A Virus (HAV), Hepatitis B Virus (HBV), Hepatitis C Virus (HCV), Hepatitis D Virus (HDV), Hepatitis E Virus (HEV), Herpes Virus, Human Cytomegalovirus, Human Immunodeficiency Virus (HIV), Human Papilloma Virus (HPV), Influenza Virus, JC Virus, Lassa Virus, Marburg Virus, Norwalk Virus, Orbivirus, Parvovirus B19, Poliovirus, Rabies Virus, Respiratory Syncytial Virus (RSV), Rhinovirus, Rotavirus, Rubella Virus, Smallpox virus, TBE Virus, Varicella-zoster Virus, West Nile Virus, Yellow Fever Virus or Zika Virus.

In some embodiments the Coronavirus is selected from the group comprising or consisting: SARS-CoV-2, HCoV-OC43, HCoV-HKU1, HCoV-229E, HCoV-NL63, MERS-CoV or SARS-CoV.

In some preferred embodiments the Coronavirus is SARS-CoV-2.

Antigens and antibodies associated with SARS CoV-2 are known and are available commercially, see for example SinoBiological https://www.sinobiological.com/antibodies/cov-spike-40592-r001 Cat number 40592-R001; and https://www.sinobiological.com/recombinant-proteins/2019-ncov-cov-spike-40592-vnah Cat number 40592-VNAH.

In addition to detecting the presence of a target analyte associated with a pathogen, the methods and chips of the invention can be used to detect the presence of a target analyte that is associated with one or more particular disease states, for example a target analyte in a biological sample.

In some embodiments the disease state is the presence of a neoplasm.

In some embodiments the target analyte comprised within the biological sample is a neoplasm, a fragment thereof, or a biomarker associated with said neoplasm.

In some embodiments the neoplasm is a neoplasm selected from the group comprising or consisting: benign tumour, cancer, carcinoma in situ, cyst, teratoma, or any combination thereof.

The benign tumour may be a benign tumour selected from the group comprising or consisting: adenoma, astrocytoma, cardiac myxoma, cholangioma, chondroma, colonic polyp, cystadenoma, ganglioma, fibroma, gastric polyp, hemangioma, hydatiform mole, leiomyoma, lipoma, liver cell adenoma, lymphangioma, meningioma, nevus, osteoma, papilloma, renal tubular adenoma, rhabdomyoma, schwannoma, squamous cell papilloma, or any combination thereof.

The carcinoma in situ or cancer may be a carcinoma in situ or cancer selected from the group comprising or consisting: carcinoma, blastoma, germ cell tumour, leukaemia, lymphoma, sarcoma, or any combination thereof.

In some embodiments the carcinoma in situ or cancer is a carcinoma in situ or cancer selected from the group comprising or consisting: Burkitt's lymphoma, acute biphenotypic leukaemia, acute eosinophilic leukaemia, acute lymphoblastic leukaemia, acute myeloid dendritic cell leukaemia, acute myeloid leukaemia, adrenocortical carcinoma, AIDS-related lymphoma, anal cancer, anaplastic large cell lymphoma, angioimmunoblastic T-cell lymphoma, appendix cancer, astrocytoma, basal cell carcinoma, B-cell prolymphocytic leukaemia, bladder cancer, brainstem glioma, breast cancer, bronchial adenomas, bronchial carcinoids, Burkitt's lymphoma, cerebellar astrocytoma, cerebral astrocytoma, cervical cancer, cholangiocarcinoma, chondrosarcoma, chronic lymphocytic leukaemia, chronic myelogenous leukaemia, colon cancer, cutaneous T-cell lymphoma, desmoplastic small round cell tumour, diffuse large B-cell lymphoma, endometrial cancer, ependymoma, epithelioid hemangioendothelioma (EHE), Ewing's sarcoma, extragonadal germ cell tumour, extrahepatic bile duct cancer, follicular lymphoma, gallbladder cancer, gastric cancer, gastrointestinal carcinoid tumour, gastrointestinal stromal tumour (GIST), gestational trophoblastic tumour, glioma, hairy cell leukaemia, head and neck cancer, heart cancer, hepatocellular cancer, hepatosplenic T-cell lymphoma, Hodgkin's lymphoma, hypopharyngeal cancer, inflammatory breast cancer, intravascular large B-cell lymphoma, invasive cribriform carcinoma, invasive lobular carcinoma, islet cell carcinoma, Kaposi sarcoma, large granular lymphocytic leukaemia, laryngeal cancer, liposarcoma, lymphomatoid granulomatosis, lymphoplasmacytic lymphoma, male breast cancer, malignant fibrous histiocytoma of bone, mantle cell lymphoma, marginal zone B-cell lymphoma, mast cell leukaemia, mediastinal large B cell lymphoma, medullary carcinoma, medulloblastoma, melanoma, merkel cell carcinoma, merkel cell carcinoma, mesothelioma, mucosa-associated lymphoid tissue lymphoma, multiple endocrine neoplasia syndrome, multiple myeloma, mycosis fungoides, myelodysplastic syndromes, nasal cavity cancer, nasopharyngeal carcinoma, neuroblastoma, nodal marginal zone B cell lymphoma, non-Hodgkin lymphoma, non-small cell lung cancer, oesophageal cancer, oligodendroglioma, oral cancer, oropharyngeal cancer, osteosarcoma, ovarian cancer, ovarian epithelial cancer, ovarian germ cell tumour, pancreatic cancer, paranasal sinus cancer, parathyroid cancer, penile cancer, pharyngeal cancer, pheochromocytoma, phyllodes tumour, pilocytic astrocytoma, pineal astrocytoma, pituitary adenoma, plasmablastic lymphoma, plasma cell neoplasm, pleuropulmonary blastoma, precursor B lymphoblastic leukaemia, primary central nervous system lymphoma, primary central nervous system lymphoma, primary cutaneous follicular lymphoma, primary cutaneous immunocytoma, primary effusion lymphoma, primitive neuroectodermal tumour, prostate cancer, rectal cancer, renal cell carcinoma, renal pelvis cancer, retinoblastoma, rhabdomyosarcoma, salivary gland cancer, Sezary syndrome, skin adnexal tumour, small cell lung cancer, splenic marginal zone lymphoma, squamous cell carcinoma, T-cell prolymphocytic leukaemia, testicular cancer, thymoma and thymic carcinoma, thyroid cancer, tubular carcinoma, ureter cancer, urethral cancer, uterine sarcoma, uveal melanoma, vaginal cancer, visual pathway and hypothalamic glioma, vulvar cancer, Wilm's tumour, or any combination thereof.

In some embodiments the cyst is a cyst selected from the group comprising or consisting: acne cyst, adrenal cyst, arachnoid cyst, Baker's cyst, Bartholin's cyst, calcifying odontogenic cyst, ceruminous cyst, chalazion cyst, choroid plexus cyst, colloid cyst, dermoid cyst, epidermoid cyst, epididymal cyst, fibrous cyst, ganglion cyst, Gartner's duct cyst, glial cyst, hydrocele testis, keratocystic odontogenic tumour, meningeal cyst, mucoid cyst, mucous cyst, myxoid cyst, Nabothian cyst, nasolabial duct cyst, odontogenic cyst, ovarian cyst, pancreatic cyst, parapelvic cyst, paratubal cyst, pericardial cyst, peritoneal cyst, pilar cyst, pilonidal cyst, pineal gland cyst, polycystic liver disease, pulmonary cyst, renal cyst, sebaceous cyst, Skene's duct cyst, spermatocele, Stafne static bone cyst, Tarlov cyst, thyroglossal cyst, trichilemmal cyst, vaginal cyst, vocal fold cyst, or any combination thereof.

By “is associated with an organism or a virus” or “is associated with a particular disease state” we include the meaning that in some embodiments the target analyte is the pathogen itself, or a fragment of the pathogen, for example a protein, peptide fragment or nucleic acid of the pathogen, for example viral nucleic acid, or a fragment of the tumour or cancer, for example. In other embodiments the target analyte is an analyte that is produced by a host in response to the presence of the pathogen or disease state. For example in some embodiments the target analyte is an antibody, for example an IgG antibody that has been produced by the host, for example by a host mammal or a host human in response to the presence of the pathogen. In some embodiments the target analyte is any analyte that, the presence of, is indicative of the presence of a particular pathogen or group of pathogens. In some embodiments the target analyte is associated with SARS-CoV-2 and in some embodiments is a portion or fragment of the SARS-CoV-2 viral particle, for example is the spike protein or fragment thereof or is the viral nucleic acid (that may have been for example amplified prior to detection) —in other embodiments the target analyte is an anti-SARS-CoV-2 antibody or fragment thereof that has been produced by a host in response to the presence of the virus. This approach can also be applied to the other pathogens described herein.

As described above, the target analyte may be any type of analyte. In some embodiments the target analyte is selected from the group comprising or consisting: nucleic acid, lipid, non-ribosomal peptides, primary metabolite, protein, peptide, carbohydrate, secondary metabolite, or any combination thereof.

In some embodiments the nucleic acid is DNA, optionally wherein the DNA is selected from the group comprising or consisting: cccDNA, ccfDNA, cDNA, cfDNA, cffDNA, circular DNA, cpDNA, ctDNA, dsDNA, eccDNA, ecDNA, eDNA, exogenous DNA, gDNA, i-DNA, linker DNA, microDNA, mtDNA, msDNA, ncDNA, rDNA, ssDNA, or any combination thereof.

In some embodiments the nucleic acid is RNA, optionally wherein the RNA is selected from the group comprising or consisting: 7SK RNA, asRNA, cfRNA, circRNA, crRNA, diRNA, dsRNA, eRNA, exRNA, gRNA, lncRNA, miRNA, natsiRNA, ncRNA, piRNA, pre-mRNA, rasiRNA, RNase MRP, RNase P, rRNA, scaRNA, sgRNA, shRNA, siRNA, SL RNA, SmY RNA, snRNA, snoRNA, ssRNA, tasiRNA, telomerase RNA, tmRNA, tRNA, tracrRNA, Y RNA, or any combination thereof.

The skilled person will appreciate that nucleic acids may comprise one or more modifications. For example in some embodiments the nucleic acid is modified nucleic acid, for example wherein the modification is selected from the group comprising or consisting: acetylation, alkylation, carboxylation, deacetylation, deamination, depurination, depyrimidination, formylation, glycosylation, methylation, phosphorylation, SUMOylation, ubiquitination, or any combination thereof.

As described above, in some embodiments the nucleic acid is a pathogen associated nucleic acid. In other embodiments the nucleic acid is associated with a neoplasm optionally associated with a neoplasm as described herein.

It will be appreciated that one advantageous feature of the chip of the invention is that it allows the multiplex detection of analytes, using a range of fluorophores selected from a range of spectral regions. Accordingly it will be clear that in some embodiments the method comprises the detection of a plurality of target analytes, for example comprises the detection of at least two, at least three, at least four, at least five, or at least six target analytes. The detection may be simultaneous or may be sequential.

In some embodiments the method comprises the detection of a plurality of analytes using a plurality of fluorophores. In some preferred embodiments at least two of the fluorophores have a peak excitation wavelength in different spectral regions, optionally wherein the different spectral regions are selected from UV, visible, NIR I and NIR II, optionally wherein the wavelength of each of the spectral regions is as follows:
UV: 100-400
VIS: 380-700
NIR I: 650-900
NIR II: 1000-1400.

In some embodiments at least 2, 3, or 4 fluorophores have peak excitation wavelengths in different spectral regions.

In some embodiments, the surface of the chip comprises one or more analyte capture agents, as described above.

In some embodiments, the analyte itself comprises a fluorophore. For example the analyte may be a protein fusion or may be a nucleic acid labelled with a fluorophore, for example via amplification and incorporation of labelled probes.

In some embodiments then the invention provides a method of detecting the presence of or amount of at least one of a plurality of target analytes, wherein the target analytes, if present, are each labelled with a different fluorophore, wherein each fluorophore has a different peak emission wavelength λ_{Em} and a different peak emission wavelength λ_{Em}, optionally wherein the method comprises the steps of:
(1) contacting the chip with a sample that may comprise said plurality of target analytes;
(2) exposing the chip to light with a wavelength (λ_{Ex}) capable of exciting at least one of the fluorophores,
(3) measuring the fluorescence intensity of the emitted light λ_{Em}; and optionally
(4) correlating the presence or intensity of the emitted light of λ_{Em} with the presence, absence or amount of a target analyte.

In some embodiments the target analyte does not comprise a fluorophore and the use of a second specific agent, a binding agent, which itself if labelled with a fluorophore is used. Such ELISA approaches are known in the field.

In some embodiments the invention provides a method of detecting the presence of or amount of at least one of a plurality of target analytes, wherein the surface of the chip comprises at least one analyte-specific capture agent Optionally wherein the method comprises the steps of:
(1) contacting the chip with a sample that may comprise said plurality of target analytes under conditions so as to allow binding of the target analyte(s) to the at least one analyte-specific capture agent(s);
(2) exposing the chip to at least one detection agent specific for each of the at least one analytes, wherein the detection agents are each labelled with a fluorophore, wherein each fluorophore has a different peak emission wavelength λ_{Em} and a different peak emission wavelength λ_{Em};
(3) exposing the chip to light with a wavelength (λ_{E}x) capable of exciting at least one of the fluorophores,
(4) measuring the fluorescence intensity of the emitted light λ_{Em}; and optionally
(5) correlating the presence or intensity of the emitted light of λ_{Em} with the presence, absence or amount of a target analyte.

It will be clear from the discussion above that the specific spectral properties of the chip can be modified or tuned to have desired characteristics by modifying a number of parameters. The presence of LSPR can readily be detected by the skilled person.

The invention therefore also provides method of tuning a chip of the invention. Preferences for this method is as described elsewhere herein, for example preferences for the composition of the chip, metallic material, dielectric core, spacing of nanostructures etc are as described herein.

In some embodiments the method comprises modifying at least one property of the chip and detecting the presence and/or properties of at least a first LSPR. The method may then comprise further modifying at least one property of the chip based on the presence or properties of the at least first LSPR and detecting the presence and/or properties of at least a second LSPR. This iterative process can be used to fine tune a chip of the invention to have the required properties for a given application, or to be suitable for use with a given set of fluorophores.

In some embodiments the method comprises assessing the ability of the chip to cause MEF of a particular fluorophore. Again, iterative modifications can be made to fine tune the chip.

The method of tuning the chip may comprise modifying at least one property of the chip to enhance the fluorescence intensity of light emitted by at least one fluorophore bound directly or indirectly to the chip.

The method of tuning the chip may comprise the steps of:
(1) modifying at least one property of the chip;
(2) exposing the modified chip to light capable of exciting at least one fluorophore bound directly or indirectly to the modified chip (i.e. wherein the fluorophore is positioned a suitable distance from the nanostructure so as to allow MEF to occur);
(3) measuring the fluorescence intensity of light of wavelength λ_{Em} emitted by the at least one fluorophore; and
(5) designating the modified chip as “tuned” or “not tuned”;
wherein the chip is considered “tuned” if the fluorescence intensity of the at least one fluorophore bound directly or indirectly to the modified chip is enhanced compared to the fluorescence intensity of the at least one fluorophore bound directly or indirectly to a chip that is not modified; and
wherein the chip is considered “not tuned” if the fluorescence intensity of the at least one fluorophore bound directly or indirectly to the modified chip is not enhanced compared to the fluorescence intensity of the at least one fluorophore bound directly or indirectly to a chip that is not modified.

The method of tuning a chip of the invention may also comprise modifying at least one property of the chip to enhance the fluorescence intensity of light emitted by a plurality of fluorophores bound directly or indirectly to the chip.

In some embodiments, each fluorophore of the plurality of fluorophores has a peak excitation wavelength (λ_{E}x) that is different to the peak excitation wavelength (λ_{E}x) of every other fluorophore of the plurality of fluorophores. In some embodiments the peak excitation wavelength of at least 2, 3, or 4 fluorophores are from different spectral regions.

In some embodiments each fluorophore of the plurality of fluorophores is capable of emitting light of emission wavelength (λ_{E}m) that is different to the emission wavelength (λ_{Em}) of every other fluorophore of the plurality of fluorophores.

Accordingly, in some embodiments the method of tuning a chip of the invention comprises the steps of:
(1) exposing the modified chip to light capable of exciting at least one fluorophore bound directly or indirectly to the modified chip;
(2) measuring the fluorescence intensity of light of wavelength λ_{Em} emitted by the at least one fluorophore; and
(3) designating the modified chip as “tuned” or “not tuned”;
wherein the chip is considered “tuned” if the fluorescence intensity of at least one fluorophore bound directly or indirectly to the modified chip is enhanced compared to the fluorescence intensity of the same at least one fluorophore bound directly or indirectly to a chip that is not modified, optionally wherein the chip is considered “tuned” if the fluorescence intensity of at least 2, 3, 4, 5, 6, 7, 8, 9, 10 or more or all fluorophores bound directly or indirectly to the modified chip is enhanced compared to the fluorescence intensity of the same fluorophore(s) bound directly or indirectly to a chip that is not modified; and
wherein the chip is considered “not tuned” if the fluorescence intensity of the at least one fluorophore bound directly or indirectly to the modified chip is not enhanced compared to the fluorescence intensity of the at least one fluorophore bound directly or indirectly to a chip that is not modified, optionally wherein the chip is considered “not tuned” if the fluorescence intensity of at least 2, 3, 4, 5, 6, 7, 8, 9, 10 or more or all fluorophores bound directly or indirectly to the modified chip is not enhanced compared to the fluorescence intensity of the same fluorophore(s) bound directly or indirectly to a chip that is not modified.

The property of the chip that may be modified may be any property. As described above and in the Examples, various features of the chip are considered to affect the spectral properties. For example in some embodiments the at least one property is selected from the group comprising or consisting of:
(i) the arrangement of the nanostructures on the substrate;
(ii) the distance between the nanostructures on the substrate;
(iii) the size of the nanostructures;
(iv) the shape of the nanostructures;
(v) the thickness of the coating of the metallic material;
(vi) the type of metallic material;
(vii) the % surface of the dielectric particle coated with the metallic material;
(viii) the dielectric material;
or any combination thereof.

It will be evident to the skilled person that since the methods and chips of the invention can be used to detect target analytes, the methods and chips are suitable for use in the diagnosis of disease. Accordingly, in one embodiment the invention provides a method of diagnosing a disease, for example where the method of diagnosis comprises the detection of a target analyte as described herein. Preferences for this aspect of the invention are as described elsewhere herein. In some embodiments, following diagnosis, an effective amount of a therapeutic composition is administered to treat the disease. Accordingly, the invention also provides methods of treating a disease, wherein the disease has been diagnosed according to any of the methods of the invention.

For example where the disease that has been diagnosed is cancer, one or more appropriate anti-cancer therapeutics can be administered.

Since the chip is capable of MEF, it is considered that the chips of the invention are particularly suitable for use in the detection of low abundance analytes, since even if the presence of the analyte is very low, the detectable signal is enhanced via MEF to detectable levels. Accordingly, the invention also provides a method for detecting a low abundance analyte wherein the method comprises any one or more of the methods described herein.

The invention also provides a method for detecting at least a first and a second analyte wherein the method comprises any one or more of the methods of the invention described herein. In some embodiments the first and/or second analyte is low abundance.

The invention also provides a method for fabricating the chip of the invention. Accordingly, the invention provides a method of producing a chip that is capable of enhancing the fluorescence of at least a first and a second fluorophore wherein the first and second fluorophore emit in two different spectral regions, wherein the method comprises:
a) arranging nanoparticles of a dielectric material on the surface of a substrate;
b) etching the dielectric material to form a dielectric core; and
c) depositing a metallic material on the dielectric core to form metallic-capped nanostructures.

Methods of depositing the nanoparticles of dielectric material on the surface of a substrate are known in the art, and can include floating the dielectric material on the surface of a liquid, followed by the perpendicular extraction of the substrate from the liquid results in the particles being deposited on the surface of the substrate. Other methods are known to the skilled person.

Preferably the nanoparticles are deposited on the surface of the substrate in a regular array, for example a regular hcp array.

The nanoparticles are then “etched” so as to form dielectric cores that are of the required shape and size, and that the distance between the dielectric cores is appropriate. Etching can result in the size of the initial dielectric core being reduced by around 5%, 10%, 15%, 20%, 25%, 30%, 35%, 40%, 45%, 50%, 55%, 60%, 65%, 70% or 75%. Etching is known in the field. In this way, the original pitch length of the polystyrene (centre to centre distance) is maintained.

Etching may be performed using reactive ion etching, for example oxygen plasma (RIE) (typically at 100 W but other parameters are also suitable). Other suitable methods are known to the skilled person.

The length of time that an initial dielectric particle is etched for affects the overall final size of the dielectric core and can be used to tune the properties of the chip. In some embodiments the dielectric particle is not etched at all, i.e. has an etch time of 0 s, and is the same as the initially arranged dielectric particle. In other embodiments, the dielectric particle is etched to reduce the diameter and/or increase the spatial separation between dielectric cores and/or change the shape of the dielectric core.

The skilled person will be able to determine an appropriate etching time. For example as shown in the Examples, etching a polystyrene nanosphere with a diameter of 575 nm (as determined by electron microscopy and which includes a 10 nm thick layer of chromium or other metal used for imaging purposes such as gold or other conductive material for visualisation purposes—i.e. an actual diameter of polystyrene of around 555 nm) for 50 s reduces the diameter of the sphere to 73% of the original value.

In some embodiments the etching time is:
at least 1 s, for example 2, 3, 4, 5, 10, 15, 20, 25, 30, 35, 40, 45, 50, 55, 60, 65, 70, 75, 80, 85, 90, 95 or at least 100 s; and/or
less than 100 s, 95, 90, 85, 80, 75, 70, 65, 60, 55, 50, 45, 40, 35, 30, 25, 20, 15, 10, 5, 4, 3, 2, or at least 1 s; and/or
from 1 s to 100 s, 2 to 95, 3 to 90, 4 to 85, 5 to 80, 10 to 75, 15 to 70, 20 to 65, 25 to 60, 30 to 55, 35 to 50, 40 to 45 s.

Following etching, the metallic material is deposited on to the dielectric cores. In some embodiments the substrate surface is also coated in the metallic material. In preferred embodiments the surface of substrate is coated in a continuous metal layer, or metal film. In other embodiments the substrate surface is not coated in the metallic material.

In one embodiment, the cap structure has a cap edge and the distance (b) between the cap edge and the surface of the metal film is:
from 1 nm and 250 nm, optionally from 2 nm and 240 nm, 3 nm and 230 nm, 3 nm and 220 nm, 5 nm and 200 nm, 10 nm and 190 nm, 15 nm and 180 nm, 20 nm and 170 nm, 25 nm and 160 nm, 30 nm and 150 nm, 40 nm and 140 nm, 50 nm and 130 nm, 60 nm and 120 nm, 70 nm and 110 nm, 80 nm and 100 nm optionally around 90 nm; and/or
at least 1 nm, or at least 2, 3, 4, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240 or at least 250 nm; and/or is less than 250 nm, or less than 240, 230, 220 210, 200, 190, 180, 170, 160, 150, 140, 130, 120, 110, 100, 95, 90, 85, 80, 75, 70, 65, 60, 55, 50, 45, 40, 35, 30, 25, 20, 15, 10, 5, 4, 3, 2, or less than 1 nm;
optionally wherein the distance (b) is 24 nm or 42 nm.

It is preferred if the cap edge is as close as possible to the underlying substrate/film whilst still retaining the cap structure—i.e. the cap edge does not touch the underlying substrate/film.

The invention also provides various kits for use in the methods of the invention. For example, in some embodiments the kit comprises one or more chips of the present invention and one or more corresponding fluorophores. A corresponding fluorophore is a fluorophore the emission of which can be enhanced via MEF with the chip. The fluorophore may be a free fluorophore for example suitable for conjugation to one or more probes, or, the fluorophore may be conjugated to one or more probe agents. For example to kit may comprise a fluorophore labelled antibody that is capable of binding to a target analyte.

In some embodiments then the kit comprises the chip of the invention, and any one or more of:
One or more corresponding fluorophores; and/or
One or more fluorophore labelled oligonucleotides; and/or
One or more fluorophore labelled antibodies or antigen binding fragments thereof.

The kit may comprise 2 or more for example 2, 3 or 4 or more fluorophores or fluorophore labelled oligonucleotides or antibody or antigen binding fragments thereof where the max excitation of two or more fluorophores are in different spectral regions.

The invention also provides a device comprising a chip of the invention. The device may be any device, for example may be a biosensing device, an environmental sample detector, a diagnostic device for example.

As described above, the chip of the invention may take the form of, for example, a lateral flow strip, a slide, a bead. These may also be considered to be devices according to the invention.

The invention provides an rt-PCR machine comprising a chip of the invention. The invention provides a biosensing device comprising a chip of the invention. The device, rt-PCR machine or biosensing device may comprise one or more analyte capture agents, optionally fluorophore labelled analyte capture agents, optionally at least two analyte capture agents labelled with different fluorophores. The device, rt-PCR machine or biosensing device may also comprise one or more analyte detecting agents, optionally fluorophore labelled analyte detecting agents, optionally at least two analyte detecting agents labelled with different fluorophores.

The invention also provides methods of imaging one or more analytes using the chip of the invention.

The listing or discussion of an apparently prior-published document in this specification should not necessarily be taken as an acknowledgement that the document is part of the state of the art or is common general knowledge.

Preferences and options for a given aspect, feature or parameter of the invention should, unless the context indicates otherwise, be regarded as having been disclosed in combination with any and all preferences and options for all other aspects, features and parameters of the invention. For example, it will be clear that amongst various combinations of features, the invention provides:
a) a chip comprising a solid substrate and a plurality of nanostructures, wherein the nanostructures comprise a dielectric core of polystyrene and a metallic cap of gold, wherein the solid substrate is glass and the nanostructures are arranged in a regular hcp array, and wherein the average diameter of the nanostructures is 300 nm;
b) chip capable of enhancing the fluorescence of each of Alexa Fluor 405, Alexa Fluor 530, Alexa Fluor 555, Alexa Fluor 647, Alexa Fluor 790 and IR-E1050;
c) a method of diagnosing an infection with SARS-CoV-2 wherein the method comprises use of a chip of the invention to detect the presence of anti-SARS-CoV-2 antibodies;
d) a chip comprising three regions, wherein each region comprises an array of nanostructures, wherein the nanostructures comprise a dielectric core of silica and a metallic cap comprising a first layer of copper and a second layer of aluminium, and wherein the distance between nanostructures in each of the three regions is different.

FIG. 1. (A) In order for MEF to be present there must be an overlap between the local surface plasmon resonance (wavelength ‘peak’ of the nanostructure) and the excitation wavelength of the fluorophore (dye). (B) There is an increase in fluorescence signal observed for the metallic nanostructure-fluorophore conjugated system compared to control, with no metal present.

FIG. 2. Tilted SEM images of silver capped nanosphere structures, using as purchased polystyrene nanospheres (Purchased as 620 nm, measured as 575 nm diameter), etched for 50 s in oxygen with varying silver coating thickness. The thickness (g) can be measured via SEM as (A-B) 55 nm, STRUCTURE 1 (C-D) 100 nm, STRUCTURE 2 (E-F) 150 nm, STRUCTURE 3 (A) is performed at a 49.8° tilt. (C-F) are perpendicular to a sample edge. (G) PS620-50 s-150 nm (STRUCTURE 3) no Cr coating. Note that a Cr coating of approximately 10 nm is present for samples A-G to aid imaging. (H) As purchased polystyrene Nanospheres (not coated in silver), etched for 50 s by RIE, down to a diameter of 418 nm (I) As purchased 620 polystyrene nanospheres, accurate diameter measurement of 575 nm

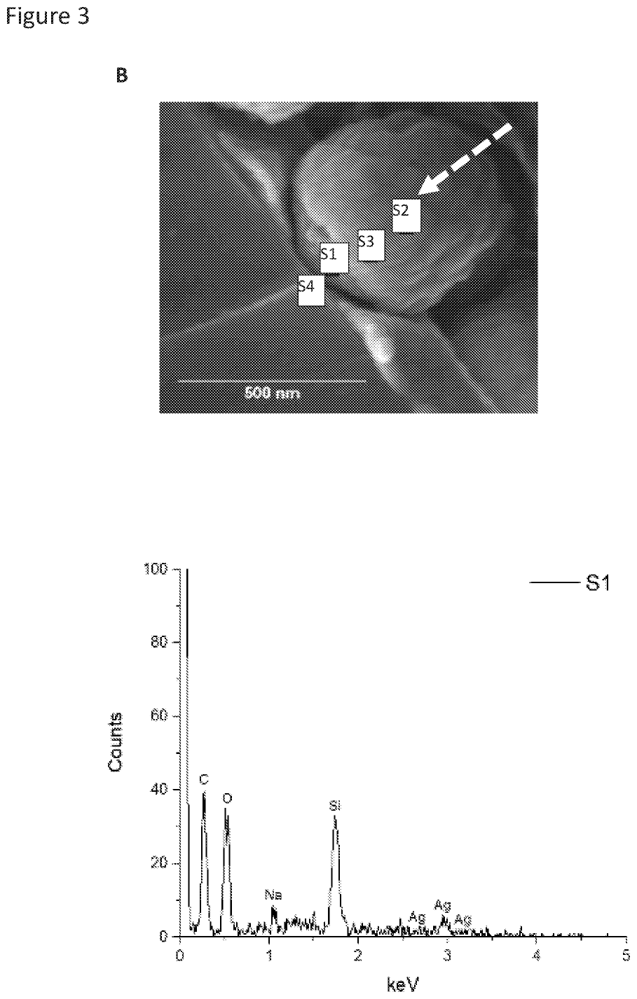

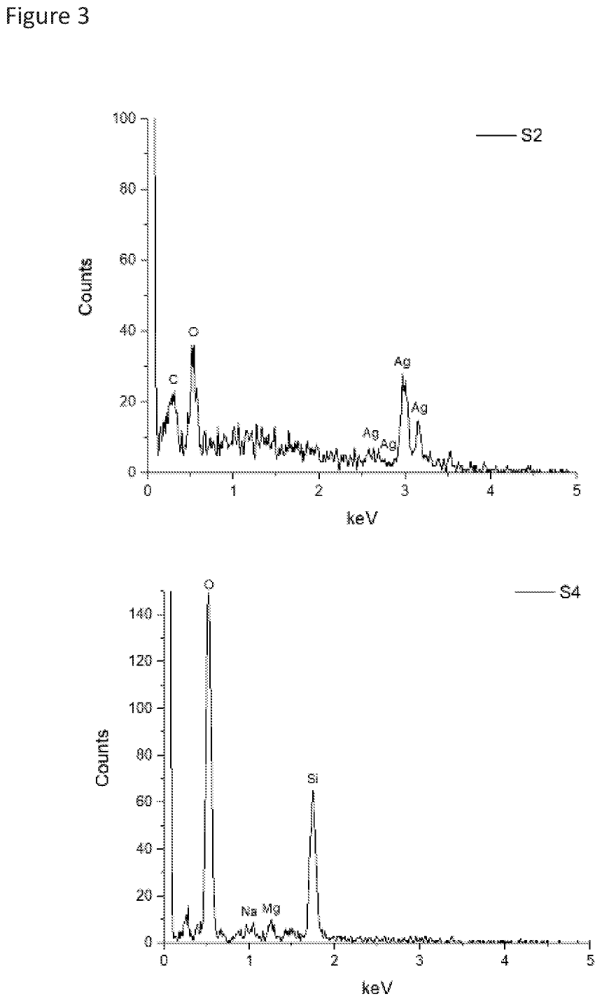

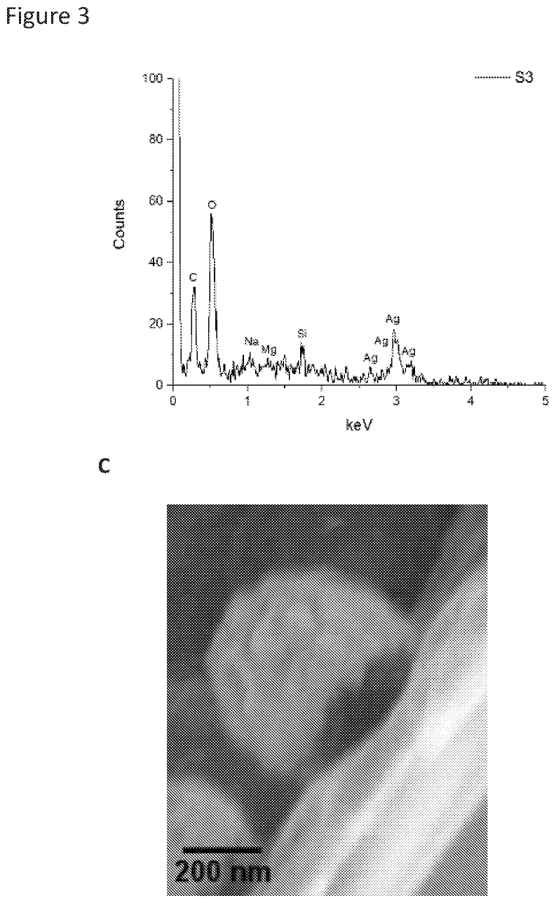

FIG. 3: A) Perpendicular SEM images of polystyrene 620 etched for 50 s in oxygen. Deposited (a) 55 nm (STRUCTURE 1) (b) 100 nm (STRUCTURE 2) and (c) 150 nm (STRUCTURE 3) of silver. Note that approximately 10 nm Cr was also used for imaging purposes. B) EDX results for analysis sites S1, S2, S3, S4 (C) Tilted SEM PS620-50 s-150 nm no Cr coating

FIG. 4. Measurements of nanostructures taken. Table 2 shows the corresponding measurements (taken via SEM) which correspond to the structures in FIGS. 2 and 3.
(a) Diameter Nanosphere (dielectric and metal)
(b) Substrate to Cap edge (capped dielectric)
(c) Total height
(d) Cap edge to metal film (between nanospheres)
(e) Internal dielectric edge to metallic outside edge of nanosphere
(f) Adjacent Nanosphere distance
(g) Film (between nanosphere) thickness

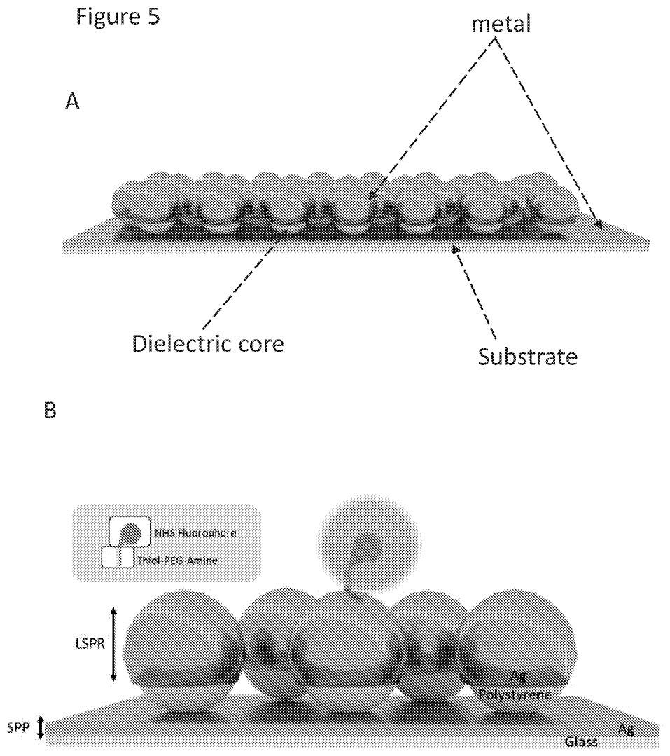

FIG. 5. A) Graphic Illustration of final structure of silver capped nanospheres. (B) Conjugation Route for fluorophore to silver capped nanospheres

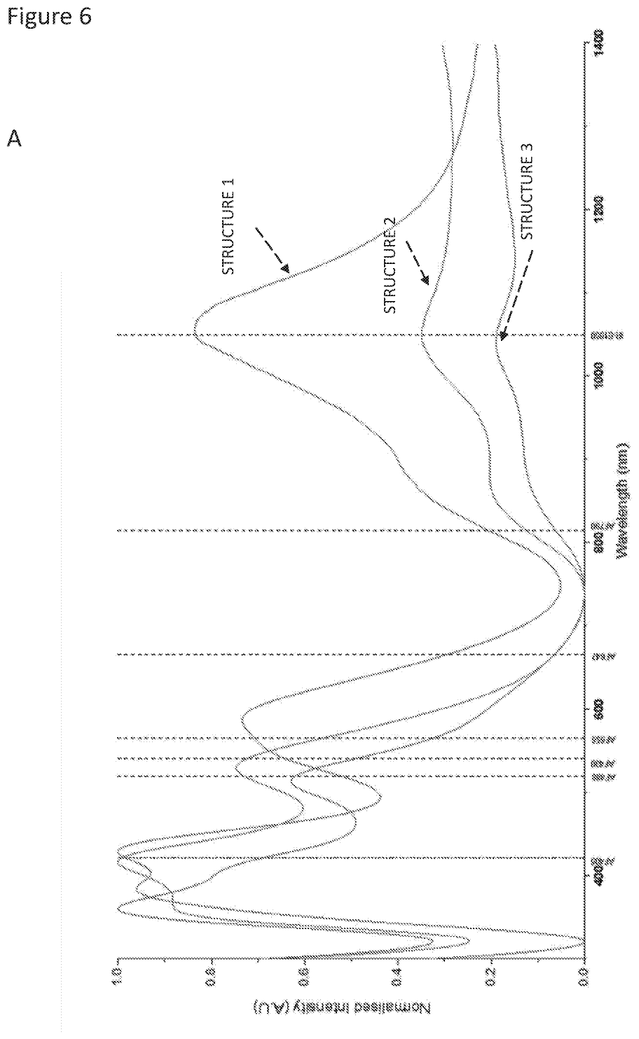

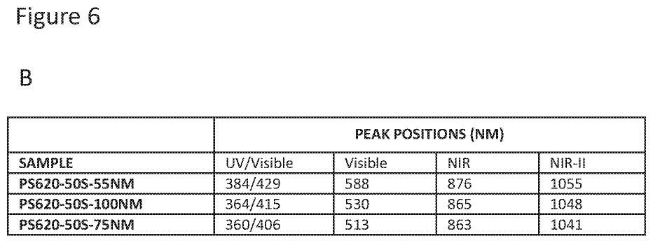

FIG. 6. A) Spectrum (Optical Extinction from UV-VIS). Demonstrating multiple ‘peaks’. Broad band within multiple spectral regions. The vertical lines indicate the emission positions of fluorophores corresponding to those investigated so far with this technology. The three structures correspond to those shown in FIGS. 2-5. B) Absorption peak positions corresponding to FIG. 3 for silver capped nanostructures based on PS620-50 s with 55 nm (STRUCTURE 1), 100 nm (STRUCTURE 2) and 150 nm (STRUCTURE 3) of silver

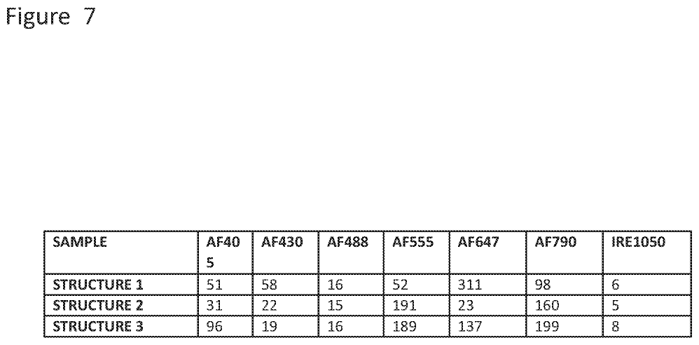

FIG. 7: Enhancement data for the example structures given in FIG. 2-6. Each fluorophore was excited at its maximum excitation as quoted by the supplier and compared to a glass control.

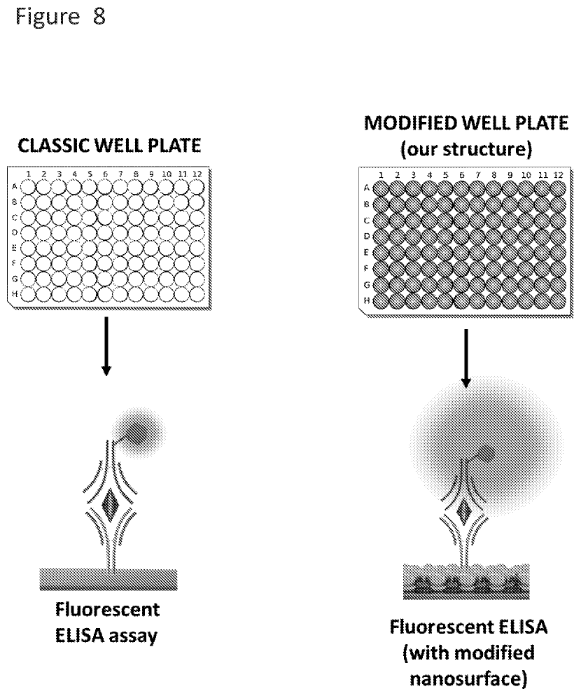

FIG. 8. Example Application of the technology. Incorporation of nanostructure into fluorescent ELISA well plates to increase the sensitivity. The modified well plate could enhance a broad range of fluorophores. The technology is not limited to a single assay or biosensing platform. For example, it could also be extended to microarray.

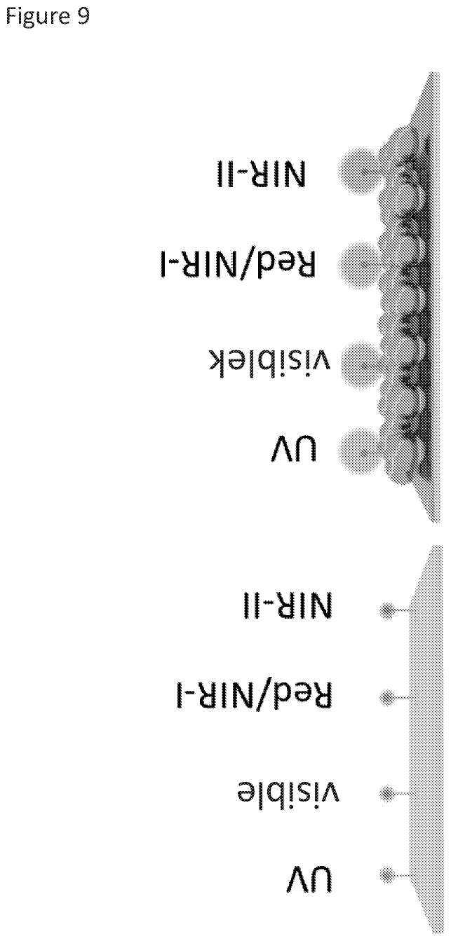

FIG. 9. Increased fluorescent signal of nanostructured platform (right) compared to glass (control, left) platform with no nanostructured coating. Single platform enhancing multiple fluorophores, within multiple spectral regions.

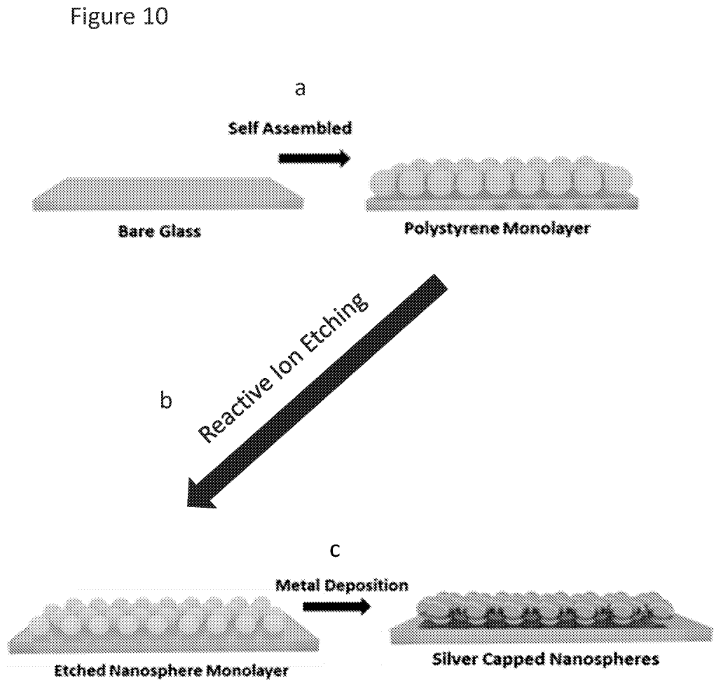

FIG. 10. Fabrication Route of Silver Capped Nanospheres, for the given example structures that are generated here. This is not the only and definitive manufacturing route.
(a) Polystyrene (dielectric) monolayers are formed on a (glass) substrate. The examples given here is via the route outlined in Example 1. Briefly this involves floating polystyrene spheres on water, whereby they self-assemble and can be transferred perpendicularly to a glass substrate.
(b) The spheres can then be etched in size using oxygen plasma in this example (c) Metallic layer(s) are coated on the spheres. Sputtering is used in this example of silver, yet another suitable deposition method could also be of use.

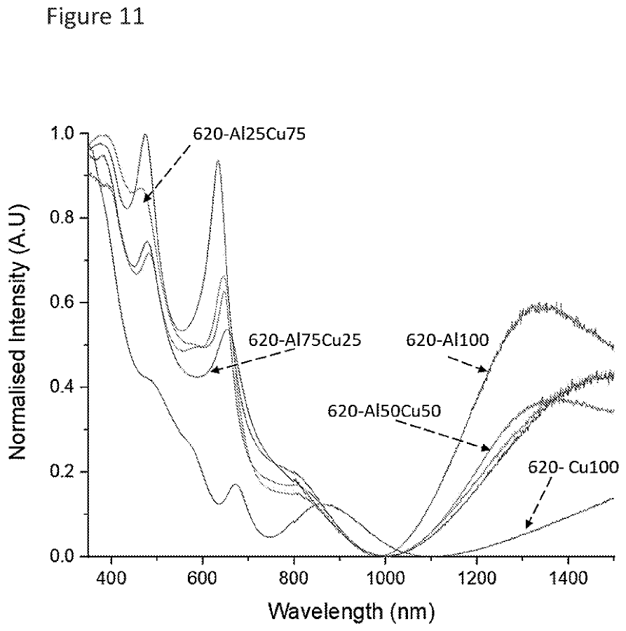

FIG. 11. Dual Layer Copper/Aluminium. Please note the notation, e.g. 620-A150Cu50 would denote a polystyrene as purchased 620 nm (Diameter measured at 575 nm) coated with 50 nm aluminium followed by 50 nm of copper.

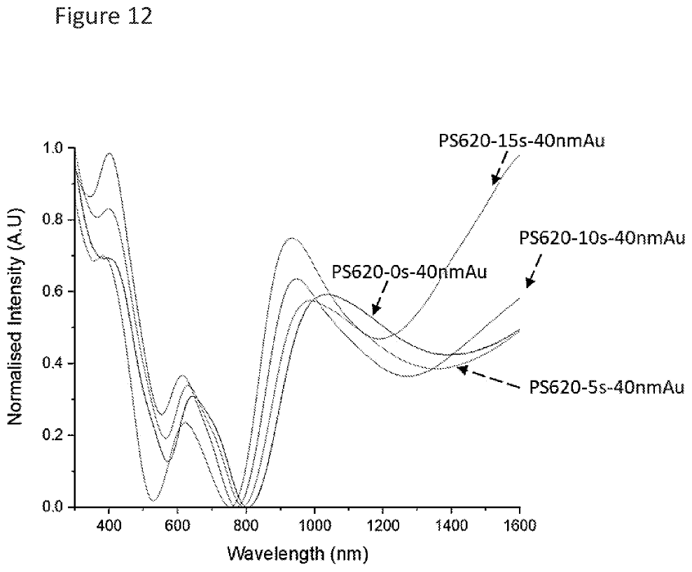

FIG. 12. Spectra Generated with Gold Capped Nanospheres, displaying a similar ‘multiple peak’ trend.

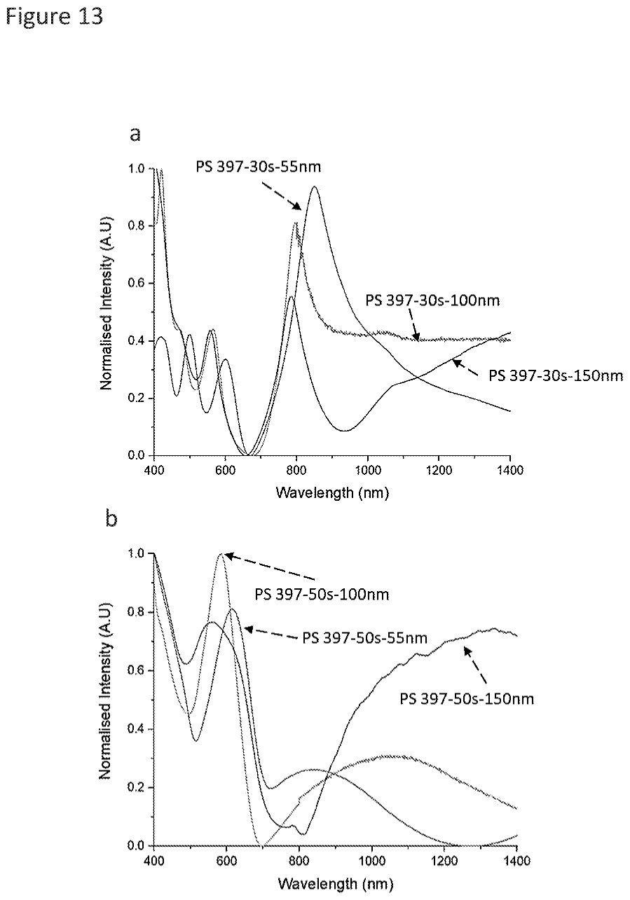

FIG. 13. (a) Spectra PS397 etched for 30 s and coated with varying silver thickness still displaying multiple peaks. (b) Spectra PS397 etched for 50 s coated with silver, not displaying multiple peaks.

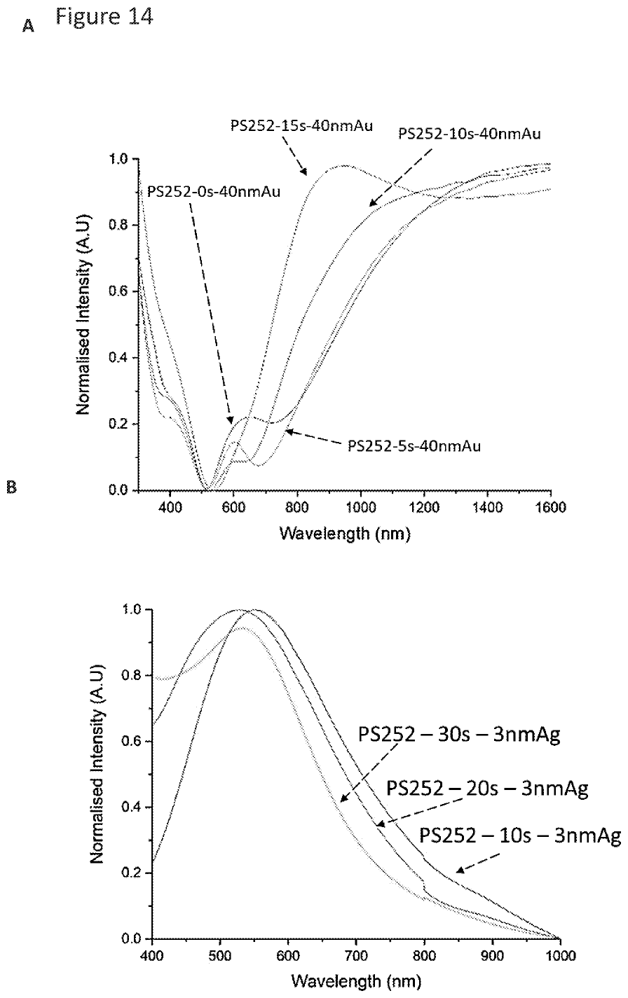

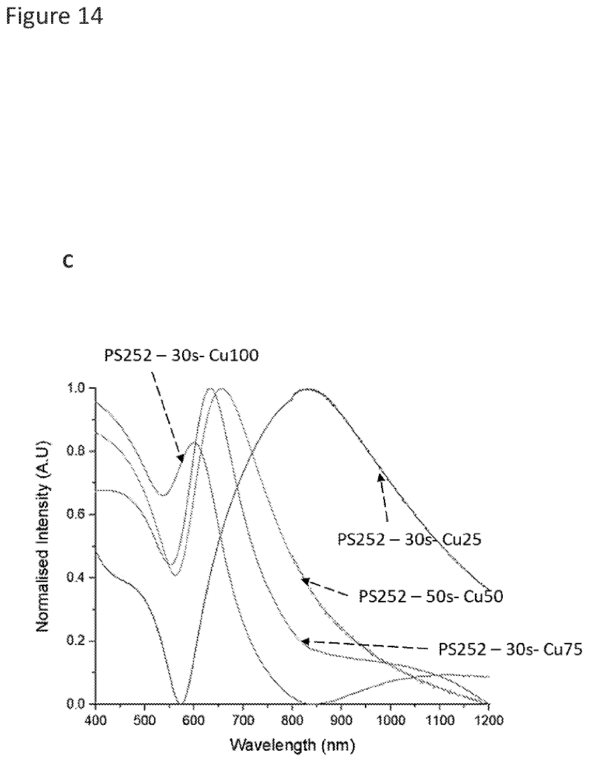

FIG. 14. A selection of metal coated nanospheres that have a smaller dielectric core and do not show broad band capabilities.
(a) This is using smaller polystyrene spheres (PS252) with gold, can see there is not the same multiple peak trend observed.
(b) This is using PS 252 with much thinner amounts of silver, only one peak is observed here, no broadband
(c) Again using PS 252, only one main plasmonic peak observed.

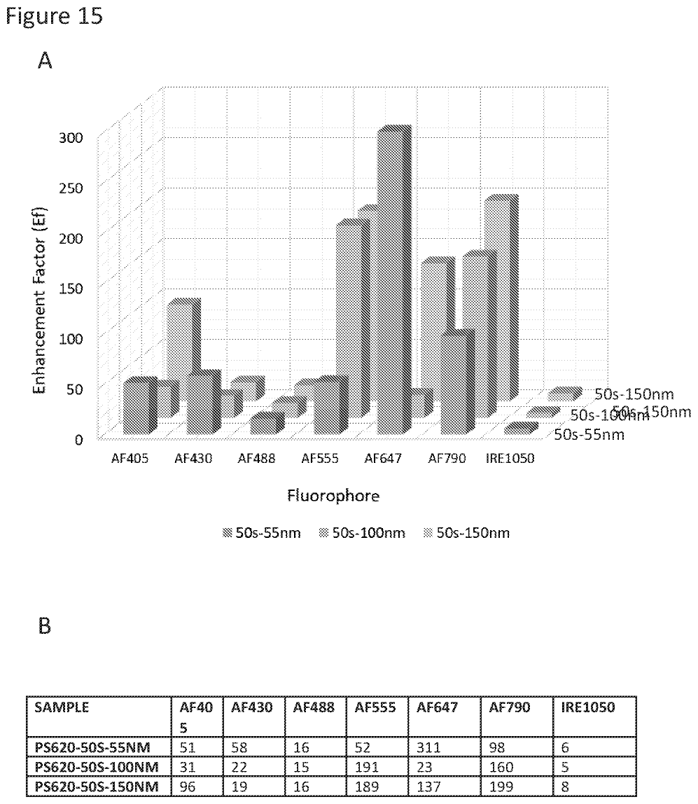

FIG. 15. A) Enhancement Factors for Silver Capped Polystyrene Nanostructures. B) Tabulated Enhancement Factors for Silver Capped Polystyrene Nanostructures

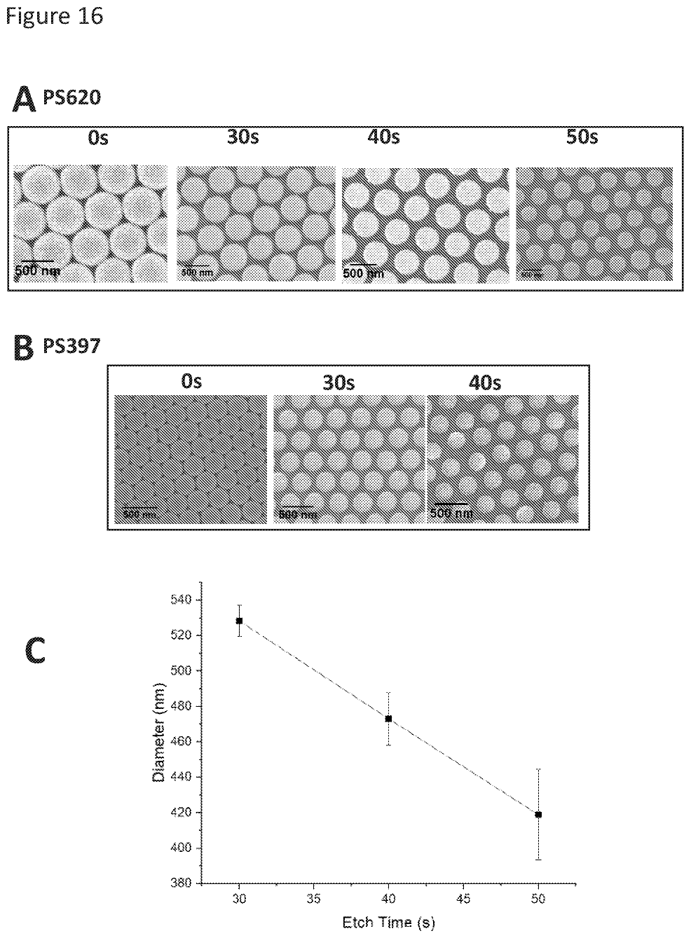

FIG. 16. SEM images of polystyrene nanosphere monolayers formed through the ‘fishing’ technique and etched with oxygen (RIE) for varying times. Polystyrene 620 (A) and 397 (B). An increase in oxygen etching time results in a smaller nanosphere diameter. (C) Polystyrene diameter variation with increasing etching time for PS620, standard deviation shown as error.

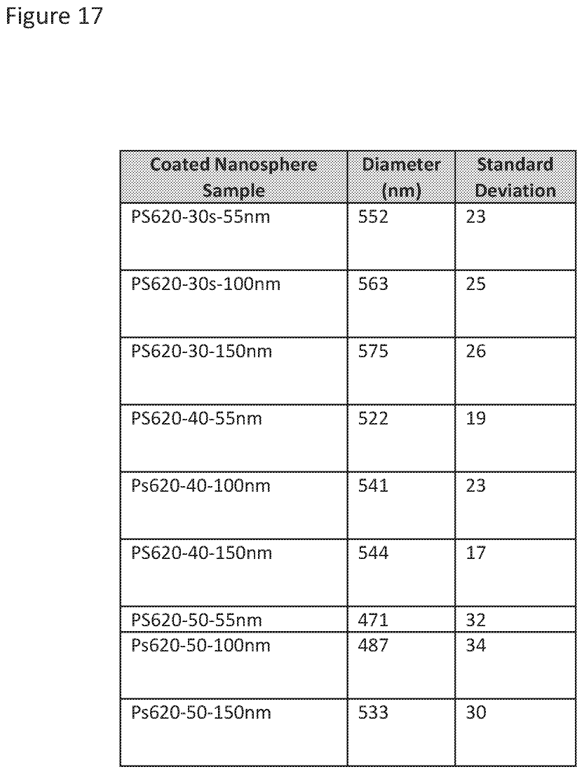

FIG. 17. Diameters and Standard Deviation of Silver Coated (PS620) nanospheres

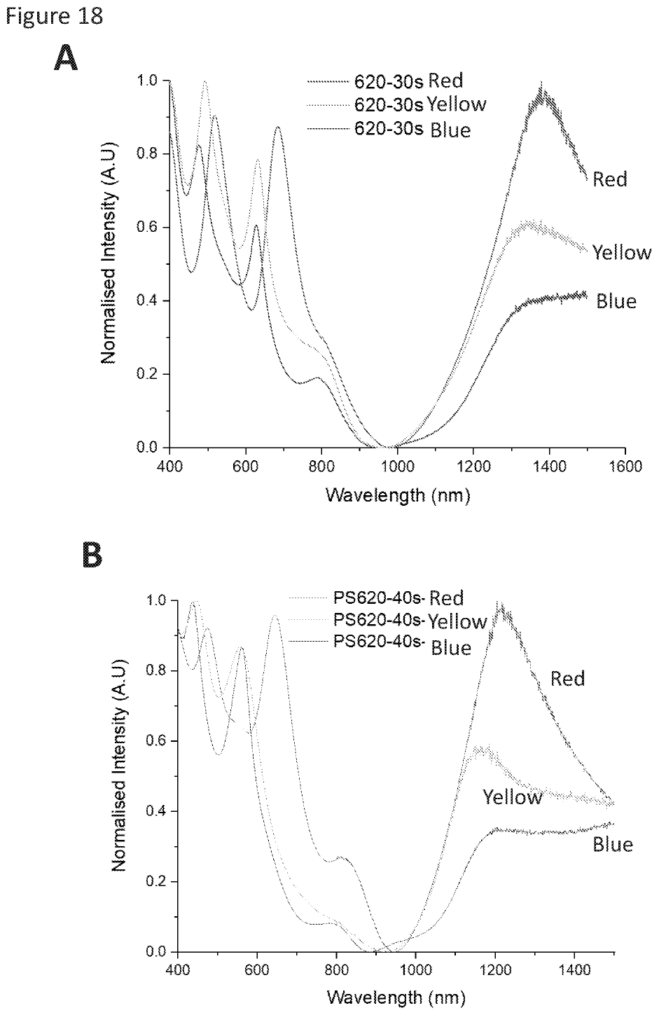

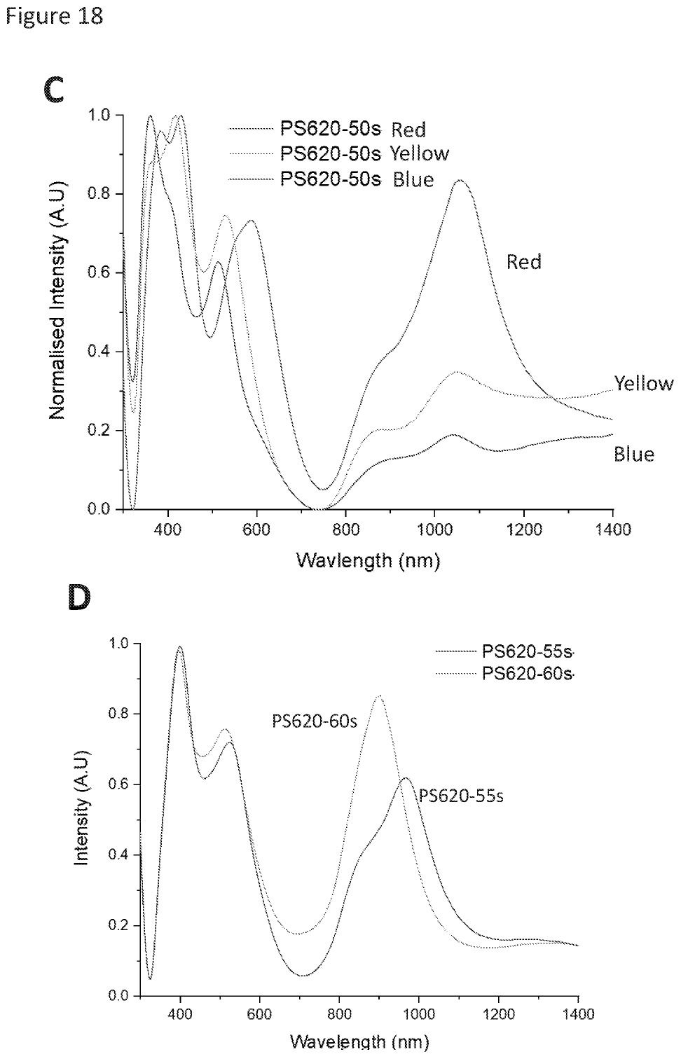

FIG. 18. (A-C) Optical Absorption for silver capped polystyrene nanospheres fabricated from PS620 and varying metal thickness (RED: 55 nm, YELLOW:100 nm BLUE:150 nm) for a fixed etching time. (A) 30 s (B) 40 s (C) 50 s. (D) Absorption spectra of PS620 with additional etching for 100 nm of Ag, given as an example to demonstrate the tunability of plasmonic response with additional etching.

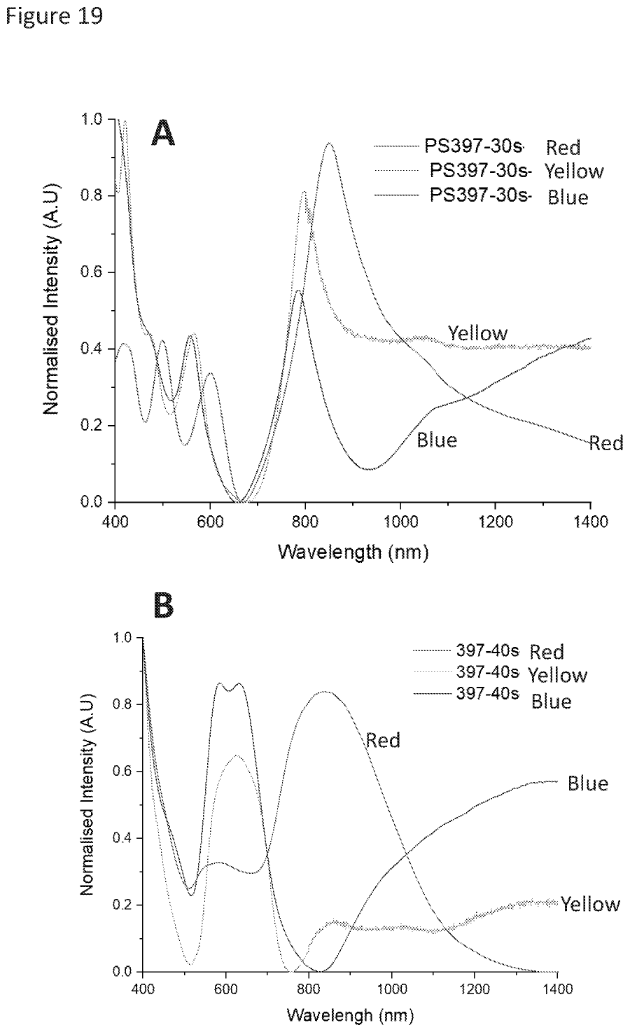

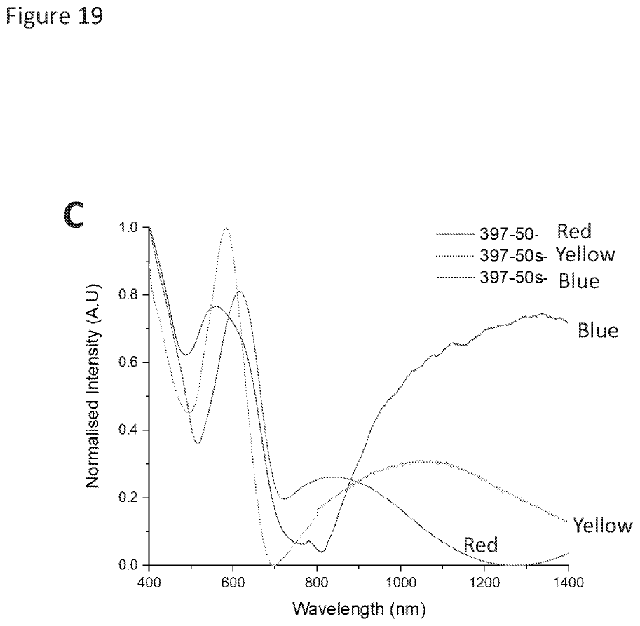

FIG. 19. (A-C) Optical Absorption Spectra for silver capped polystyrene nanospheres fabricated from PS397 and varying metal thickness (RED: 55 nm, YELLOW:100 nm BLUE:150 nm) for a fixed etching time. (A) 30 s (B) 40 s (C) 50 s.

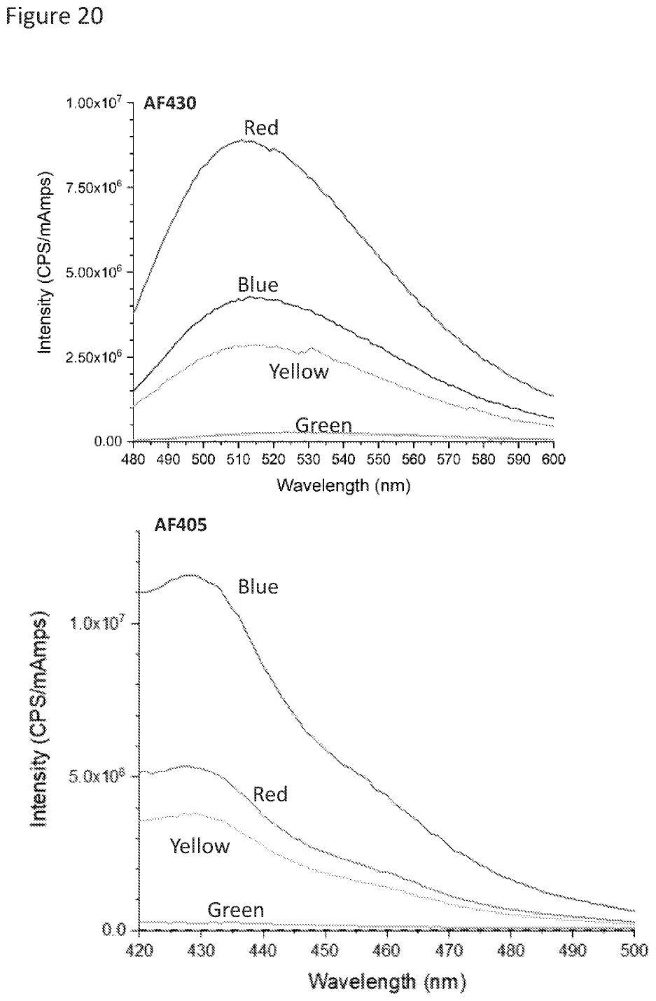

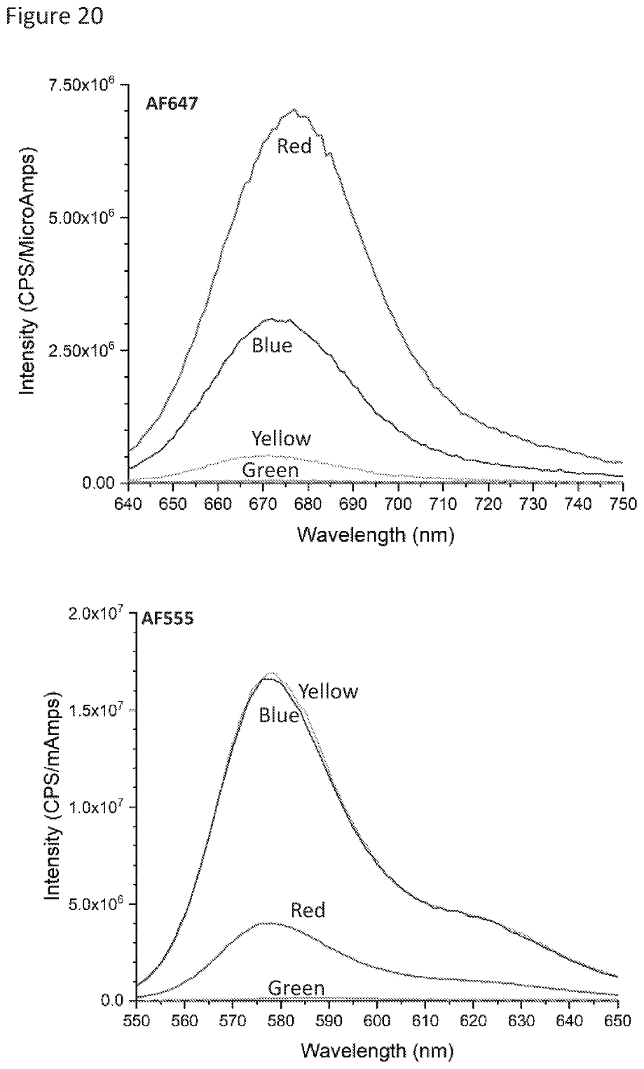

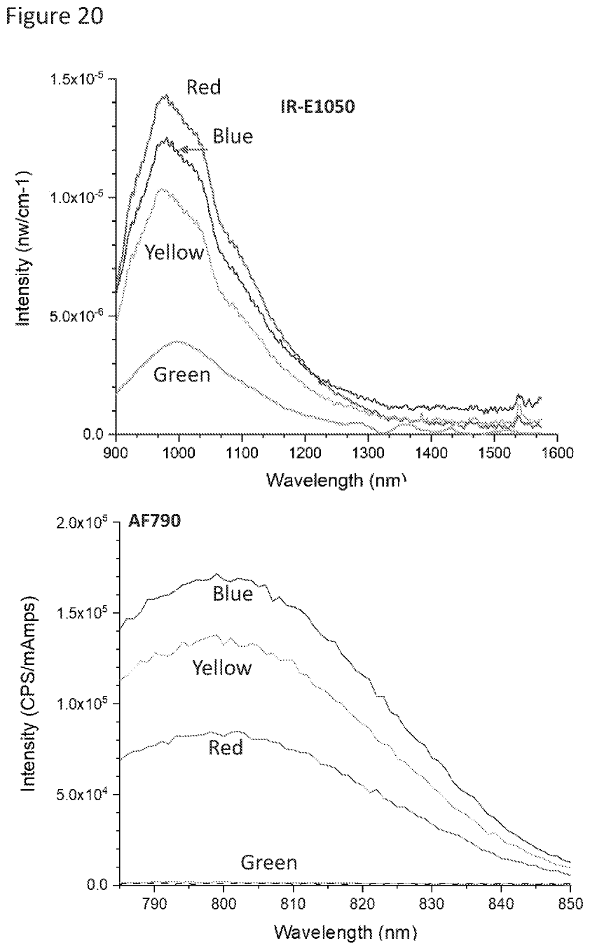

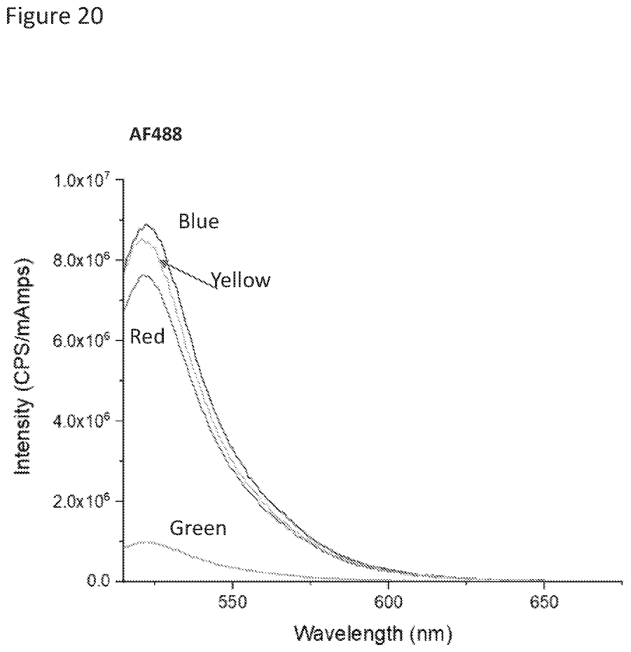

FIG. 20. Fluorescent Enhancement Spectral Data for silver capped nanostructures based on PS620-50 s with 55 (red), 100 (yellow) and 150 (blue) nm of silver. Glass-Fluorophore is shown in green, glass only is the dotted line. IR-E1050

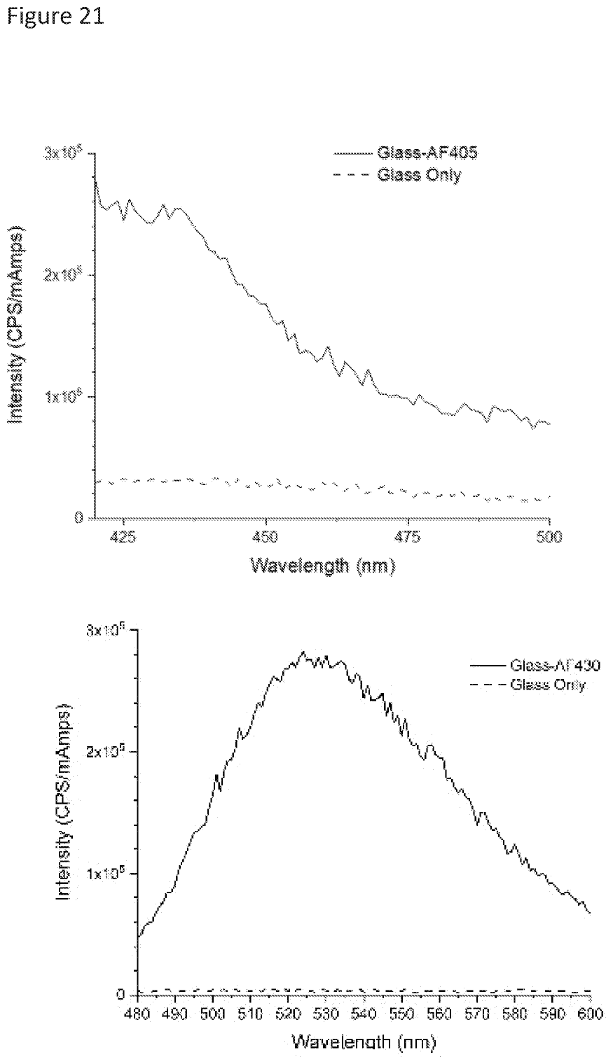

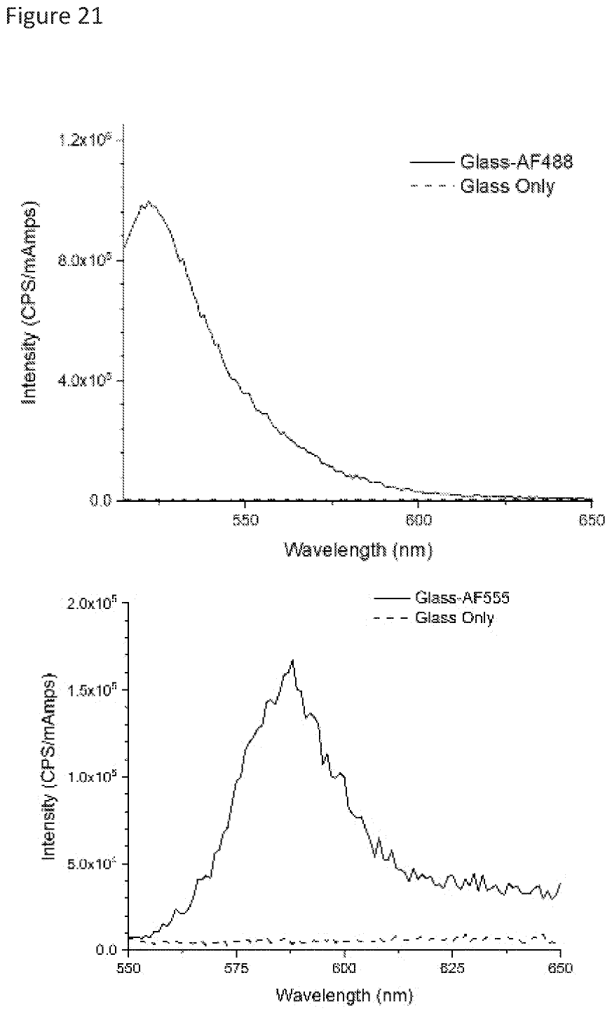

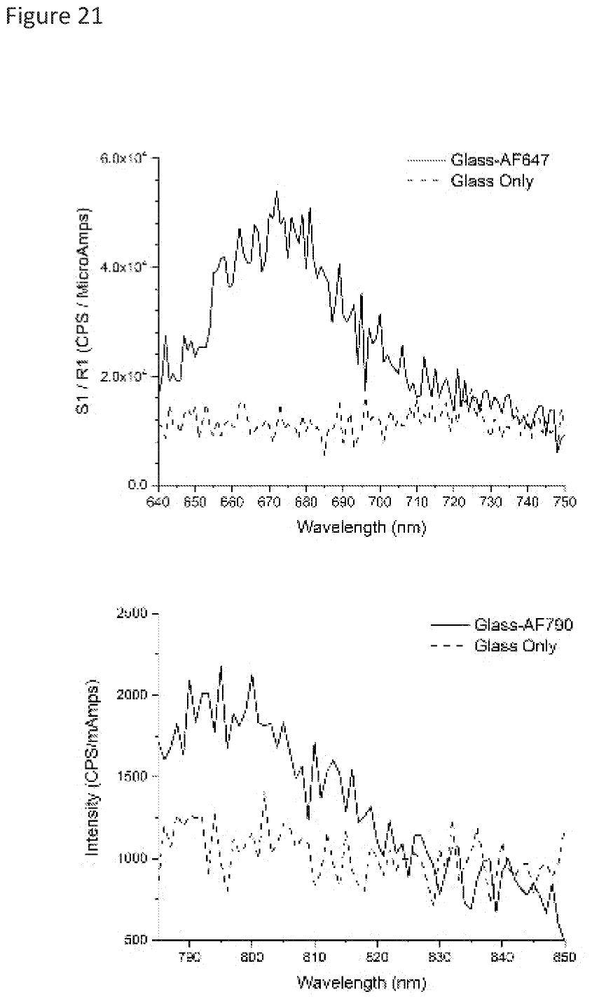

FIG. 21. Spectral Data for Glass-Dye and Glass only used as background and control measurements for calculation of enhancement factors.

### REFERENCES

[1]K. Aslan, I. Gryczynski, J. Malicka, E. Matveeva, J. R. Lakowicz, C. D. Geddes, Curr. Opin. Biotechnol. 16 (2005) 55-62.
[2]S. M. Fothergill, C. Joyce, F. Xie, Nanoscale 10 (2018) 20914.
[3]I. G. Theodorou, Z. A. R. Jawad, Q. Jiang, E. O. Aboagye, A. E. Porter, M. P. Ryan, F. Xie, Chem. Mater. 29 (2017) 6916-6926.
[4]J. S. Pang, I. G. Theodorou, A. Centeno, P. K. Petrov, N. M. Alford, M. P. Ryan, F. Xie, (2019).
[5]Z. A. R. Jawad, I. G. Theodorou, L. R. Jiao, F. Xie, Sci. Rep. 7 (2017) 14309.
[6]S. M. Tabakman, L. Lau, J. T. Robinson, J. Price, S. P. Sherlock, H. Wang, B. Zhang, Z. Chen, S. Tangsombatvisit, J. A. Jarrell, P. J. Utz, H. Dai, Nat. Commun. 2 (2011).
[7]I. G. Theodorou, P. Ruenraroengsak, D. A. Gonzalez-Carter, Q. Jiang, E. Yague, E. O. Aboagye, R. Charles Coombes, A. E. Porter, M. P. Ryan, F. Xie, Nanoscale 11 (2019) 2079.
[8]Y. Chen, K. Munechika, D. S. Ginger, Nano Lett. 7 (2007) 690-696.
[9]N. C. Lindquist, P. Nagpal, K. M. Mcpeak, J. Phys. D Appl. Phys 48 (n.d.).
[10](n.d.).
[11]C. Joyce, S. M. Fothergill, F. Xie, Mater. Today Adv. 7 (2020).
[12]J. Bartelmess, S. J. Quinn, S. Giordani, Chem. Soc. Rev. 44 (2015) 4672-4698.
[13]M. Holzinger, A. Le Goff, S. Cosnier, Front. Chem. 2 (2014) 1-10.
[14]G. Hong, A. L. Antaris, H. Dai, Nat. Biomed. Eng. 1 (2017) 10.
[15]A. M. Smith, M. C. Mancini, S. Nie, Nat. Nanotechnol. 4 (2009) 710-711.
[16]A. L. Antaris, H. Chen, S. Diao, Z. Ma, Z. Zhang, S. Zhu, J. Wang, A. X. Lozano, Q. Fan, L. Chew, M. Zhu, K. Cheng, X. Hong, H. Dai, Z. Cheng, Nat. Commun. 8 (2017) 1-11.
[17]Y. Sun, M. Ding, X. Zeng, Y. Xiao, H. Wu, H. Zhou, B. Ding, C. Qu, W. Hou, A. Er-Bu, Y. Zhang, Z. Cheng, X. Hong, Chem. Sci. 8 (2017) 3489-3493.
[18]L. Guo, J. A. Jackman, H. H. Yang, P. Chen, N.J. Cho, D. H. Kim, Nano Today 10 (2015) 213-239.
[19]B. Zhang, R. B. Kumar, H. Dai, B. J. Feldman, Nat. Med. 20 (2014) 948-953.
[20]B. Zhang, B. A. Pinsky, J. S. Ananta, S. Zhao, S. Arulkumar, H. Wan, M. K. Sahoo, J. Abeynayake, J. J. Waggoner, C. Hopes, M. Tang, H. Dai, Nat. Med. 23 (2017) 548-550.
[21]M. F. Elshal, J. P. McCoy, Methods 38 (2006) 317-323.
[22]M. F. Templin, D. Stoll, M. Schrenk, P. C. Traub, C. F. Vöhringer, T. O. Joos, Drug Discov. Today 7 (2002) 815-822.
[23]P. Schena, M., Shalon, D., Davis, R. and Brown, Adv. Sci. 270 (1995) 467-470.
[24]W. Deng, F. Xie, H. T. M. C. M. Baltar, E. M. Goldys, Phys. Chem. Chem. Phys. 15 (2013) 15695-15708.
[25]C. D. Geddes, J. R. Lakowicz, J. Fluoresc. 12 (2002) 121-129.
[26]J. Gao, C. M. Bender, C. J. Murphy, Langmuir 19 (2003) 9065-9070.
[27]B. Sun, C. Wang, S. Han, Y. Hu, L. Zhang, RSC Adv. 6 (2016) 61109-61118.
[28]J. Pang, I. G. Theodorou, A. Centeno, P. K. Petrov, N. M. Alford, M. P. Ryan, F. Xie, J. Mater. Chem. C 5 (2017) 917-925.
[29]F. Xie, M. S. Baker, E. M. Goldys, Chem. Mater. 20 (2008) 1788-1797.
[30]X. Huang, M. A. El-Sayed, J. Adv. Res. 1 (2010) 13-28.
[31]A. Centeno, F. Xie, N. Alford, J. Opt. Soc. Am. B 28 (2011) 325-330.
[32]S. K. Balasubramanian, L. Yang, L. Y. L. Yung, C. N. Ong, W. Y. Ong, L. E. Yu, Biomaterials 31 (2010) 9023-9030.
[33]F. Xie, A. Centeno, M. R. Ryan, D. J. Riley, N. M. Alford, J. Mater. Chem. B 1 (2013) 536-543.
[34](n.d.).
[35]F. Zang, Z. Su, L. Zhou, K. Konduru, G. Kaplan, S. Y. Chou, Adv. Mater. 31 (2019) 1902331.
[36]K. Sugawa, T. Tamura, H. Tahara, D. Yamaguchi, T. Akiyama, J. Otsuki, Y. Kusaka, N. Fukuda, H. Ushijima, ACS Nano 7 (2013) 9997-10010.
[37]J. S. Pang, I. G. Theodorou, A. Centeno, P. K. Petrov, N. M. Alford, M. P. Ryan, F. Xie, (2019).
[38]J. R. Vig, in: Proc.—Electrochem. Soc., Publ by Electrochemical Soc Inc, 1990, pp. 105-113.
[39]M. Puchalski, P. Dąbrowski, W. Olejniczak, P. Krukowski, P. Kowalczyk, K. Polanski, The Study of Silver Nanoparticles by Scanning Electron Microscopy, Energy Dispersive X-Ray Analysis and Scanning Tunnelling Microscopy, 2007.
[40]F. Le, D. W. Brandl, Y. A. Urzhumov, H. Wang, J. Kundu, N.J. Halas, J. Aizpurua, P. Nordlander, (n.d.).
[41]H. Wang, G. P. Goodrich, F. Tam, C. Oubre, P. Nordlander, N.J. Halas, (n.d.).
[42]S. J. Oldenburg, R. D. Averitt, S. L. Westcott, N.J. Halas, Chem. Phys. Lett. 288 (1998) 243-247.
[43]C. Farcau, Sci. Rep. 9 (2019).
[44]M. B. Cortie, F. Liu, M. D. Arnold, Y. Niidome, (2012).
[45]S. Souri, N. Hadilou, H. A. Navid, R. Sadighi Bonabi, A. Anvari, Sci. Reports 2021 111 11 (2021) 1-13.
[46]D. Lee, J. Lee, J. Song, M. Jen, Y. Pang, Phys. Chem. Chem. Phys. 21 (2019) 11599.
[47]M. A. Badshah, N.Y. Koh, A. W. Zia, N. Abbas, Z. Zahra, M. W. Saleem, Nanomaterials 10 (2020) 1-22.
[48]D. Mann, D. Nascimento-Duplat, H. Keul, M. Möller, M. Verheijen, M. Xu, H. P. Urbach, & Aurele, J. L. Adam, P. Buskens, (n.d.).
[49](n.d.).
[50](n.d.).
[51]B. da Silva Fanta, J. Birkedal, A C S Appl. Mater. Interfaces 9 (2017) 37374-37385.
[52]T. G. Habteyes, S. Dhuey, E. Wood, D. Gargas, S. Cabrini, P. J. Schuck, A. P. Alivisatos, S. R. Leone, (2012).
[53]D. T. Debu, P. K. Ghosh, D. French, J. B. Herzog, Opt. Mater. Express 7 (2017) 73.

### EXAMPLES

### Example 1—Producing Chips of the Invention

FIG. 1 provides information on MEF. In order for MEF to be present there must be an overlap between the local surface plasmon resonance (wavelength ‘peak’ of the nanostructure) and the excitation wavelength of the fluorophore (dye) (A). (B) There is an increase in fluorescence signal observed for the metallic nanostructure-fluorophore conjugated system compared to control, with no metal present.

Chips of the present invention were typically generated as follows (see also FIG. 10).

Polystyrene microspheres with a quoted diameter of 620 nm (10%) were purchased (typically from Bangs Laboratories Inc, USA), (PS620, measured via SEM as 575 nm). Thiol-Polyethylene glycol-amine (MW 7500), Thiol-Polyethylene glycol-methyl (MW2500), Dimethyl sulfoxide and sodium borate buffer (pH 8.5) and (3-Aminopropyl)triethoxysilane were all purchased from Sigma Aldrich. Nanopure water (>18.2 MOhms), purified using the Millipore Milli-Q gradient system, was used in all experiments. Glass microscope slides were obtained from VWR International and rinsed with acetone, IPA and water before use or cleaned via other suitable method. Alexa Fluor dyes where purchased from Sigma Aldrich purchased as succalymide esters (STP). IR-E1050 was purchased from Nirmidas Biotech). P-Type silicon wafers were purchased from PiKem.

The ordered silver capped arrays (or other metal capped arrays) were produced using a simplistic modified colloidal lithography method in order to allow for precise nanoscale control of the size and inter particle separation. This was following a widely reported method. Firstly, templates of polystyrene (PS) sphere monolayers were fabricated on the surface of glass wafers. Briefly, 60-100 μL of polystyrene spheres solution in ethanol (1:1 ratio) was applied to a clean silicon wafer hung vertically. This was then slowly submerged into a glass container filled with deionized water. A monolayer of PS particles was formed on the surface of the water. This was then transferred to glass (1 cm×1 cm) substrates which had been ozone cleaned, and then allowed to dry for 1 hour at approximately a 30° angle. Addition of a 2% sodium dodecyl sulfate solution modified the water surface tension allowing for large monolayers with highly ordered areas to be obtained. The PS nanospheres were then treated with RIE using 02 with an etch time of 30 s, 40 s and 50 s, using an 02 pressure of 20 Pa, RF power of 100 W and 02 flow of 20 sccm. Following this, Ag sputtering on a Mantis Deposition System was performed for varying thicknesses. An argon gas flow of 200 sccm was used, with a voltage of 630V and a current of 200 mA. FIG. 10 summarises the synthesis steps taken for this example.

For surface modification of the metallic nanostructures, a 9:1 ratio of sPEG to mPEG was used. Briefly, 10 mM solutions of both PEGs were prepared separately in ethanol. This was then mixed in a 9:1 ratio. The resultant solution was drop cast onto the surface of the nanostructures and allowed to conjugate for up to 2 hours at a concentration of 50 μL/cm2. In order to prevent the ethanol from evaporating, the slides were left in a humid atmosphere. This was performed by enclosing the substrates within a petri dish (or similar) with water droplets on the surface. After this time, the slides were carefully washed with 50 μL of ethanol 5 times and air dried. In order to attach the NHS ester fluorophores, the nanostructures (and control) must first be modified with amine groups through PEGylation or APTES modification. Fluorophore preparation was performed using the provided information on Sigma Aldrich. Briefly, the fluorophores (1 mg) were dissolved in 100 μL DMSO. Sonication was performed to ensure the fluorophore was fully dissolved. From here 2 μL of each was added to a 1 mL solution of sodium borate buffer (pH 8.5) and vortexed. This was applied at a concentration of 40 μL/cm2 for each dye by drop casting separately onto individual samples such that a sample (and control) was prepared for every dye. This was left for another 2 hours in a dark, humid environment. Excess unconjugated solution was collected and quantified, to allow for accurate calculation of the surface coverage and correction factor. All samples were gently air dried before any fluorescence studies and stored in the dark.

Arrays were characterised using an SEM using a LEO Gemini 1525 field emission scanning electron microscope (FEG-SEM), typically at 5 keV. The SEM was operated both in perpendicular view and tilted view, in order to assess both the top and side morphology of the nanostructures and the extent of metallic coating.

EDX analysis was performed to determine the extent of the surface metallic coating. SEM measurements and analysis was performed using Image J software. The optical properties of the resultant nanostructures were assessed using UV-VIS-NIR-II Spectroscopy. Fluorescence spectroscopy is a type of analysis that measures the fluorescence from a sample. In the case, measurements were carried out on two machines. From UV to NIR-I, the Fluorolog®-s Model FL3-22 (Jobin Yvon Horiba) was the preferred choice, whereas for NIR-II, the NS1 NanoSpectralyser™ was used. Both are capable of exciting fluorophore molecules (at their respective peak absorption wavelengths) and measuring the emitted fluorescence.

### Example 2—Properties of the Chips of the Invention

Three structures are presented here STRUCTURE 1, STRUCTURE 2 and STRUCTURE 3. The resultant SEM images can be seen in FIG. 2 and FIG. 3. The dimensions of the example three structures are given in FIG. 4.

The SEM images show that the self-assembled method produces regular polystyrene nanosphere arrays in hexagonal close packed structure (FIG. 2H, 2I). Using RIE, the size of the nanospheres can be controlled as well as separation distance between adjacent nanospheres. An increase in etching time results in decreased polystyrene diameter. The position of the nanosphere remains fixed and thus the pitch length (distance from one centre to the next) also does not change. When the nanoparticle length was plotted against the etching time, a directly proportional relationship was observed between the two parameters (R=0.99).

It is important to note that the as purchased polystyrene is in fact slightly smaller that reported by the manufacturer. For replication of the plasmonic properties, polystyrene with the measured diameter would be required for future substrates. As you increase the etching time the overall diameter of the nanosphere for a given metallic thickness decreases (FIGS. 16 and 1). This is to be expected due to the reduction of the polystyrene through the RIE process. The second, is that for a fixed etching time the overall diameter of the nanosphere structure increases as the metallic thickness is increased up to 150 nm. For example, 50 s-55 nm has the smallest diameter, which is unsurprising given it has been etched for the longest time (50 s) and had the lowest amount of silver deposition. It is worth noting that during the imaging process 10 nm of chromium is deposited on each sample and thus the true diameter will be slightly smaller, however as each sample has had the same amount of chromium deposited onto its surface then the trends still apply. The standard deviation is the average amount of variability in a data set reveals on average how far each score lies from the mean. Firstly, it demonstrates both a lack of uniformity between the polystyrene spheres that have been purchased and the resultant etched polystyrene sphere diameters. This suggests that the etching process may not be perfectly uniform, such that some spheres are etched more than others. It is unclear why this is but may result as a consequence of the positioning of the samples within the reactive ion etcher. Secondly, the standard deviation appears to be larger for the increased etching (50 s) compared to the lower etching (30 s). This may be a consequence of longer etching times producing larger variation in the reactive ion etcher. Finally, and most importantly, the slight variation in the diameter of the spheres, and possible anisotropic nature of the structures, may be one explanation for the multiple plasmonic peaks that are observed within the structure. It was chosen to image a selection of the nanostructures through tilted SEM in order to further characterise the morphology. Tilted SEM was performed for PS620-50 s. Although it has not been confirmed, it is reasonable to assume, that having the lowest initial polystyrene sphere diameter, it is likely that if this set of structures was not fully coated, then larger polystyrene spheres would too not be coated, given the larger area for the same metallic thickness that would need to be covered.

Although SEM images taken perpendicular to the sample surface does allow for the diameter of individual nanostructures to be measures, it reveals very little about the coverage of the nanospheres on the sides. Sputtering, unlike evaporation is not line of sight and it was initially therefore expected that the metallic coating would cover most, if not all, the polystyrene nanosphere. However, without tilted SEM this could not be confirmed. In addition to this, as the polystyrene nanosphere is large in comparison to the metal layer thickness, this raised uncertainty to if the silver would evenly cover the whole sphere, particularly the undersides. Two types of tilted SEM were performed. The first involved loading the sample perpendicular to the beam direction and tilting the SEM stage. This was performed for one sample (FIG. 2A) and provided a quick and initial understanding of the coverage. Upon tilting at 49.8°, darker areas below the nanospheres were observed, that were not consistent with the contrast that would be achieved if this were metal. This suggested areas that were not covered with silver. The second imaging route involved loading the samples into the SEM chamber with the edge of a sample at a 90° to the beam direction. This route was more effective for assessing the coverage of the polystyrene nanospheres. FIGS. 2B-2G show the side profile of the nanostructures. As can be seen, the coverage is not complete on the polystyrene nanosphere. The silver forms a ‘cap’ on the polystyrene.

FIG. 4B shows a range of measurements that can be taken using side profile imaging. An increase in film thickness, increases the nanosphere diameter, consistent with the measurements shown in Table of FIG. 4. As a consequence of this the distance between adjacent nanospheres decreases. An increase in film thickness also causes a decrease in the gap between metallic cap and the surface of the glass (measurement b in FIG. 4). There is also a decrease in the distance between the cap edge and the surface of the metallic film (measurement d). As these are brought closer together, there would be an increase in coupling, resulting in more intense ‘hot spots’ between these two areas. It is possible by using the size of the polystyrene nanosphere and the full height of the capped nanosphere measurement to infer the thickness of the metallic film at the top of each structure (measurement e in FIG. 4). As the top of the polystyrene nanosphere is the area most exposed during sputtering, it was expected for this thickness to be similar to the deposited film thickness.

One observation from the tilted SEM is the presence of small nanoparticles below the ‘cap’ of the polystyrene nanospheres, for example in FIG. 2C on the polystyrene. It has previously been reported that sputtering does not produce a clean line of metallic coating coverage and that small nanoparticles may also be present on the side of structures (in this case the lower part of the polystyrene nanospheres). As chromium or other metal used for imaging purposes such as gold or other conductive material (chromium used in the Examples here) must be used as a coating for tilted SEM on non-conducting samples (the polystyrene) at a thin thickness (approximately 10 nm), it was unclear if these nanoparticles were a result of silver or chromium. FIG. 2G shows a sample imaged without the chromium coating, demonstrating a higher contrast between the metal cap and the polystyrene. This suggested that some of the nanoparticles present below to cap were in fact chromium. This was a difficult image to obtain, and it was not possible or recommended to image all tilted samples without chromium, due to charging of the sample.

### EDX

Although from initial tilted SEM images, it was suspected that the polystyrene spheres were indeed not fully coated with silver, energy-dispersive X-ray spectroscopy (EDX/EDS) was used to confirm the surface composition. Four sites of analysis were performed as shown in FIG. 3B. The beam direction was angled towards the surface of the sample as indicated by the arrow in FIG. 3B. The spot size of the primary beam of electrons was 5 keV.

S1 shows a high intensity of carbon and oxygen, confirming the presence of polystyrene which is carbon rich. There is also a high intensity of silicon, which results from the glass surface below where the beam also will be hitting. There are some small peaks due to silver, but this is likely due to the detection of emitted X-rays from the surrounding silver or minor nanoparticles as a result of sputtering. When compared to S2, the quantity of silver is negligible. S2 shows a high intensity of silver, which is to be expected on the metallic surface layer. It is worth noting that there are still peaks present for carbon and oxygen, which may arise from residual polystyrene, adsorbed surface contaminants, or from any oxide layer present. However, the carbon counts are much lower than that for S1 suggesting a significant difference in surface composition. Silver displays multiple peaks, due to the multiple electronic transitions that are present (K and L lines) and the characteristic lines here are consistent with literature[39]. S3 is on the edge of both the polystyrene nanosphere and the silver cap. Compared to position S2, this displays a lower count of silver, yet shows an increase in in carbon, oxygen, and silicon. It is likely this beam is exciting and detecting emitted X-rays from the silver, polystyrene, and the glass simultaneously. It is worth noting that Na and Mg become present, which arise from impurities in the glass. Finally, at S4, the X-rays are only collected from the glass substrate. As a result, there are no silver peaks, but a large intensity for Si and O (SiO₂ network of glass) and an increase in Na and Mg impurities. It is possible from this EDX data to confirm that the nanostructures are silver capped polystyrene nanospheres with incomplete silver coverage.

### Optical Properties of Silver Capped Nanospheres

The UV-Vis-NIR spectroscopy was recorded for the silver capped nanospheres synthesised. Interestingly, for all nanostructures that are synthesised with PS620, multiple peaks are observed as opposed to one single peak (FIG. 6). These are highly complex structures with a complex LSPR. There are multiple factors that may be influencing the complex LSPR. There be many modes which may be present, for example edge modes and gap modes. There is anisotropy of the nanostructures that are produced, along with the large standard deviation in diameters may be producing a variation in plasmonic response and LSPR and potential peak broadening. Compared to much smaller nanostructures, the nanospheres will exhibit multiple dipoles resulting in multiple LSPR peaks. Indeed, for all nanostructures synthesised with PS620, at least 3 peaks are observed. The arrays will exhibit a coupling affect between adjacent nanospheres on the surface which may to be creating hybrid modes. It is also worth noting that these structures will not just exhibit LSPR but also SPP, as created by the silver film surrounding the nanospheres. It is therefore possible that this may lead to LSPR and SPP coupling, particularly in areas whereby the cap and the film are within closer proximity.

There be many modes which may be present, for example edge modes and gap modes. There is anisotropy of the nanostructures that are produced, along with the large standard deviation in diameters may be producing a variation in plasmonic response and LSPR and potential peak broadening. Secondly, compared to much smaller nanostructures, the larger nanospheres will exhibit multiple dipoles resulting in multiple LSPR peaks. There may also be hybridisation between individual nano shell plasmons[40]. Finally, it is possible that the arrays will exhibit a coupling affect between adjacent nanospheres on the surface which may be creating hybrid modes. Indeed, for all nanostructures synthesised with PS620, at least 3 peaks are observed.

Although an increase in metallic coating would increase the size and thus typically cause a redshifted spectrum (as larger structures are redshifted compared to their counterparts), the observed trend is in fact the opposite. This variation may be as a result of the shell structure and not a solid sphere. This may be attributed to the influence of the metallic layer and the polystyrene nanosphere. Coupling between metallic and dielectric typically causes a red shift in the LSPR position. As the metallic layer is becoming thicker, the extent of this coupling is decreasing, lessening the effect of the spectral shift. Therefore, this is dominating over the size influence. Because the core dimensions do not change in this process, the redshift may be explained due to shell thickness.

When comparing the same thickness for different etching times, there is a decrease in the peak absorption position as the etching time is increased (FIG. 18 For example, when comparing PS620-30 s-55 nm to PS620-50 s-55 nm, there is a blue shift over 300 nm for the NIR-II peak position (1381 nm compared to 1055 nm). Again, this is consistent with previous experimental such that a decreasing core shell ratio causes blue shift. For the majority of the work presented throughout this work, an interval of 10 s has been chosen for etching times, however by decreasing the etching time interval even further to a 5 s interval it is possible to fine tune the plasmonic response to a greater extent (FIG. 18d). This may be useful when requiring specific overlap between selected fluorophores.

In order to investigate the plasmonic properties of the silver capped polystyrene nanostructure further, a smaller size polystyrene (PS397) was also used in the fabrication (FIG. 19). When comparing the spectra to that of PS620 a similar trend is observed such that an increase in metallic thickness, as well as a decrease in etching time causes a red shift in the plasmonic response, consistent with previous experimental studies[42]. When considering the fixed etching time of 30 s, there are multiple peaks in the optical absorption spectra, however this has been blue shifted in comparison to its PS620 counterpart. Multiple plasmonic peaks are still observed, again suggesting the formation of a complex modal structure associated with the complex geometry[44].

When moving towards an increased etching time for PS397 (40 s, 50 s) there is a reduction in the number of peaks that are observed. One explanation for this could be the reduction in hybrid modes and dipoles that are formed between adjacent nanostructures. As the etching time increases, distance between adjacent nanospheres decreases. As PS397 is smaller than PS620, the relative distance increases. This suggests there may be a limitation to the relative nanosphere distance that still provides multiple plasmonic peaks. However, further modelling would be required to fully understand these responses.

Importantly here, through modifying both the metal thickness and the sphere diameter, it is possible to tune the plasmonic response of the resultant nanostructures, such that multiple spectral features are present. It is important to note the broad nature of some of the peaks presented. This may be explained due to the slight variations of polystyrene sphere diameter through the fabrication route or minor inconsistencies in film thickness and roughness caused through sputtering. Indeed, previous studies have demonstrated that asymmetric shells can lead to splitting of the plasmon resonances[45]. Silver has been known to exhibit absorption within the UV, Visible and NIR-I[46,47] range which has been highly dependent on the morphology chosen. The extension to include a NIR-II peak can be attributed to the presence of the polystyrene core which has been shown to typically cause a redshift in nanostructure plasmonic with increasing core diameter[48].

The aim of this methodology is to demonstrate that a single platform can be used to enhance from near UV-NIR-II, which is subsequently performed and the focus of this work. The optical responses demonstrated here are complex, and although some trends can be explained using previous literature, it is suggested that future work include modelling of structures. Nevertheless, the presence of multiple peaks on a single platform, could be incredibly useful for biosensing applications, offering not only a versatile tool, but also the potential for multiplexing with multiple fluorophores.

### Broad Band Fluorescence Enhancement

There is huge tunability in the optical response of the silver capped polystyrene nanostructures. It was chosen to investigate the enhancement factor of a variety of common fluorophores across the spectrum from near-UV to NIR-II. Here, the example data set for PS620-50 s is presented, as this provides a broad spectrum with multiple peaks with good overlap with the chosen fluorophores.

Seven fluorophores were investigated in this study, six common Alexa Fluor dyes and one novel fluorophore emitting in NIR-II, IRE1050.

In order to conjugate the fluorophore to the substrate surface, the conjugation methods and EDC NHS chemistry route is chosen. First, the EDC reacts with the carboxylic acid group to form an intermediate group. This intermediate can be easily displaced by nucleophilic attack from primary amines. The amine reactive group forms an amide bond with the original carboxyl group and an EDC by product is released. To be an efficient reaction, acidic conditions (pH 4.5) are preferred, but buffers up to pH 7.2 are still suitable although offering lower efficiency. 4-morpholinoethanesulfonic acid (MES) is the suggested buffer of choice. The inclusion of N-Hydroxysuccinamide (NHS), is frequently added to improve the efficiency of reaction. Carboxyls can be coupled to NHS using EDC, forming an NHS ester which is a more stable intermediate. This provides a more efficient conjugation to primary amines[49,50]. Deemed as ‘EDC/NHS’ chemistry, this reaction mechanism is used as a route to conjugate IE-E1050-COOH to amine modified surfaces. Most of the fluorophores that are presented in this work are purchased as Alexa Fluor® NHS amine reactive probes. These are favoured over COOH functionalised fluorophores as they do not require EDC/NHS activation chemistry. NHS esters are reactive groups that have been formed already through carbodiimide-activation of carboxylate molecules. Put simply, as purchased NHS Ester fluorophores are pre-activated or prepared for reaction with primary amines. They do not require EDC/NHS activation, and this makes them a favourable fluorophore.

To react with primary amines, the NHS esters must be prepared in slightly alkaline solutions (pH 7.2 to 9). When in solution, the NHS Ester begins hydrolysing, however within this pH range, the rate of hydrolysis is reduced, aiding the formation of stable amide bonds. A borate buffer (pH 8.5) is suggested for this reaction, which can be performed at room temperature. Upon reaction an NHS molecule is released. The NHS ester fluorophores purchased are in solid/pellet format. These are water-insoluble and must be dissolved in a water miscible organic solvent such as dimethyl sulfoxide (DMSO) or Dimethylformamide (DMF). DMSO was the chosen solvent for these fluorophores in these reactions, and upon addition to aqueous solution, they are sonicated to dissolve thoroughly.

For all Alexa Fluor fluorophores, the NHS ester conjugation route was used. For the attachment of the NIR fluorophore IR-E1050-COOH, the EDC/NHS attachment route was chosen.

The fluorescent enhancement is a measure that is used to compare the fluorescent intensity of a fluorescent nanostructure compared to that of a glass control. Upon measuring the fluorescent intensity, the peak values can be compared. In its basic form it can considered as the ratio between the nanostructured and unstructured fluorescent intensities. In order to calculate this, a monolayer of fluorophores must be attached to both sample and control.

This uncorrected enhancement factor may be expressed as [3]:

$${E}_{f} = \frac{{I}_{metal / dye}}{{I}_{glass / dye}} \qquad ( Eq . 1 )$$

Here I is the intensity at a given wavelength and the subscripts represent the substrate, either nanostructured metal or glass conjugated with dye molecules. A background signal must be subtracted to account for any fluorescence caused by the glass, linker molecule or background measurement caused by the machine or environment. A glass sample is used as this background. PEG and APTES are not known to fluorescence, and thus glass only is sufficient, however, in some research papers, for example those using bBSA as a linker molecule (which displays some native fluorescence itself), the modified glass may be used[3].

$${E}_{f} = \frac{{I}_{metal / dye} - {I}_{glass}}{{I}_{glass / dye} - {I}_{glass}} \qquad ( Eq . 2 )$$

So far, this equation assumes that the substrates are of equal size and surface area. Although the observed sample size may be the same (i.e 1 cm²), the actual surface area will vary between the nanostructured and glass control surfaces. Therefore, a correction factor must be included to account for this.

$${E}_{f} = \frac{{I}_{metal / dye} - {I}_{glass}}{{I}_{glass / dye} - {I}_{glass}} \cdot \frac{[ {Dye}_{metal} ]}{[ {Dye}_{glass} ]} \qquad ( Eq . 3 )$$

This additional term accounts for the difference in surface area between any resultant nanostructure and therefore the fluorophore concentration on the surface.

The enhancement factors are displayed in FIG. 15. An explanation for each fluorophore is first given here as well as an explanation for the difference between different fluorophores.

For AF405, a metallic coating of 150 nm provides the greatest enhancement at a value of 96 times. When comparing the overlap in optical properties, sample 150 nm has a peak at 406 nm that forms a shoulder to a secondary peak at 360 nm. This peak at 405 nm overlaps with the optical properties of the fluorophore, as thus may explain the increased enhancement compared to the 55 and 100 nm samples. When comparing the remaining two samples for this fluorophore, their plasmonic responses are similar and both consist of two peaks that overlap with one another. The increase in enhancement for sample 55 nm compared to 100 nm could be explained by the reduced wavelength difference between the two peaks in the 55 nm, which may combine to a stronger plasmonic effect upon the fluorophore. All three samples investigated present good overlap with AF405 optical properties. may be due to increased emission overlap.

When moving towards AF430 however, the trend shifts. Here, the overlap between the plasmonic properties of the samples formed with 150 nm of silver and the fluorophore drops to be much less overlap than with AF405. Instead, the sample formed with 55 nm has an almost ideal overlap with the optical properties of the fluorophore, which likely accounts for the greatest enhancement that is observed. The sample prepared with 100 nm, has a greater overlap with the optical properties of the fluorophore compared to the 150 nm sample (415 nm compared to 405 nm), however the level of enhancement observed between the two is similar. It is again likely that the increase in hotspots in the 150 nm sample is increasing the number of hot spots more than for the 50 nm, thus increasing the final enhancement factor.

For AF488, the enhancement for the 55, 100 and 150 nm samples are moderate at only 16, 16 and 15 times, respectively. AF488 is already a very bright fluorophore with a quantum yield of 0.92, thus these low enhancements are expected, as the quantum yield has a maximum value of 1 (see literature chapter) and thus there are already lower losses in the system. There is a similar degree in overlap between the absorption/emission properties of this fluorophore with each sample.

All samples perform well using AF555. This fluorophore has a low quantum yield (only 0.1), lower than most Alexa Fluor dyes. The enhancement factor for low quantum yield dyes is known to be greater than that for fluorophores with high quantum yields. With low quantum yields, there are greater loses in the system, however, the presence of the metallic nanostructure provides an additional excitation channel and improved quantum yield. The nanostructure prepared with 55 nm of silver has the lowest enhancement observed here, which is likely due to having the least overlap in optical properties. Despite this, 52 times enhancement is still a respectable enhancement for metal enhanced fluorescence-based biosensors. Both the 100 nm and 150 nm samples have a similar enhancement, of nearing 200 times (191 and 189 respectively). Again, it is clear that the coupling affect and formation of hotspots may be influencing the outcome. The nanostructure formed with 100 nm of silver has a better overlap with the fluorophore (55 nm away from the peak position compared to 42 nm), however both enhancements are of the same order of magnitude. Indeed, the hotspot formation for both samples may be influencing the outcome to result in this large enhancement factor, but this will be of a greater extent for the 150 nm sample.

For AF647, the highest enhancement achieved is for 55 nm of Ag, whereas the lowest is for 100 nm of Ag. This again may be attributed to the largest overlap being for the 55 nm sample. The enhancement for the 150 nm sample still remains high at 137 times, which may be again explained by the closer proximity of adjacent nanostructures as well as the cap and the film.

For AF790, all three samples show high enhancement factors (FIG. 15). This is surprising, given the relatively low overlap with the plasmonic peaks. The quantum yield of this fluorophore is low at only 4%[3], which partially may explain the high enhancement factors achieved. As the metallic thickness increases the enhancement factor also increases, which is due to a combination of both the increased overlap in optical properties and the increased presence of hotspots as the metallic thickness increases. In a similar manor to AF555, AF790 has a low quantum yield, which again, allows for relatively high enhancements to be achieved compared to fluorophores with higher yields. This is a nevertheless a promising result for the use of this substrate for NIR applications, suggesting that if the optical properties were to overlap even more, then an even greater enhancement could be achieved.

For IRE1050, although there is good overlap in the emission properties of the dye, there is poor overlap in the absorption, however good overlap in emission. It may be the emission enhancement contributing more to the overall fluorescence enhancement. The fluorophore is enhanced much less than the fluorophores in this visible or NIR-II. Nevertheless, there appears to be some trend in the enhancement factors achieved. The sample prepared with 150 nm of silver has the largest enhancement, which can be explained by having the best overlap with the fluorophore. Both the 55 nm and 100 nm sample are similar in their enhancement and peaks position (6 and 5). It is evident that the overlap with IRE1050 could be further improved, through fine tuning of the plasmonic nanostructure even more, an in particular improved emission overlap. Nevertheless, the broad plasmonic properties in the NIR-II is promising, for applications within this spectral region. By tuning the nanostructure further, increased enhancement may have retrospectively been achieved with IRE1050.

Nevertheless, this work has provided a single broad band enhancing platform, which can perform across the spectra.

All fluorophores were excited at their peak excitation wavelength as quoted by the supplier.

This has demonstrated for the first time, the ability for a nanostructure to enhance across the spectrum. This has been validated with a variety of common Alexa Fluor dyes, as well as the novel IRE1050 (FIG. 7). Fluorescence is a powerful research tool, and the ability to enhance a wide range of wavelengths with a single platform offers versatility to a user, as well as the potential for multiplexing. By altering the size of the nanostructures, as well as the metallic thickness, the plasmonic response can be tuned, to allow for increased overlap with the desired fluorophores. In addition, a simplistic fabrication route is chosen to obtain the substrates, which may allow for rapid fabrication and upscale, both of which are crucial for clinical application.

All nanostructures that are investigated here have the potential for metal enhanced fluorescence, on a solid platform which is useful for immunoassay-based sensing. The next step would to be to use this platform for any analyte of interest. When considering ELISA type assays for example, the conjugation of antibodies to the nanostructure surface is required. As there is an enormous number of potential antibodies available, this chapter has not aimed to incorporate one single antibody, but rather provide a proof of concept that a single platform could be incorporated into existing biosensing methodologies applicable to multiple fluorophores. For example, the generation of a nanostructured silver well plate could be incredibly useful in the life sciences. By substituting standard well plates for the nano silver well plates, an increase in fluorescence could be achieved, increasing sensitivity, and ultimately leading to a more sensitive analysis.

By designing a nanostructured metal, as shown here, that can perform across a variety of wavelengths, this allows for the desired spectral region to be selected depending on the fluorescent assay required and the available fluorescent scanner.

### Example 3—Effect of Using Different Metallic Material

FIG. 11—data generated using similar polystyrene spheres, but instead uses copper and aluminium. This is for a fixed etching time (same size polystyrene diameter). It also includes dual layers of metals. Please note the notation, e.g. 620-Al50Cu50 would denote a polystyrene as purchased 620 (measured as 575 nm) coated with 50 nm aluminium followed by 50 nm of copper. This manufacturing route is the same that as shown in FIG. 10, yet uses different metal(s). The etch time for each of these samples is 30 s. Note that not all of these demonstrate the same broad band pattern, but it does show a similar trend for some data sets. Therefore, it is understood that this broadband effect may not just be limited to silver, yet may be extended to additional metal(s).

This has also been extended to investigation with gold and lower etching times (see next section)

### Example 4—Effect of Different Etching Times and Sphere Diameters

Nanostructures were produced that include both a different metal (gold) as well as lower etching times, which would result in spheres closer to the unetched original diameter. (FIG. 12). A similar trend is observed using gold. It is worth noting here that 0 s etching equates to a full-size polystyrene sphere (i.e as purchased, no modification, just coated with metal).

FIG. 13 shows polystyrene of diameter 397 nm that has been etched by 30 s and by 50 s. For the 30 s data set it is clear that there appears to be multiple peaks and that as the thickness of the silver in this case increases then the whole spectra blue shifts. It is clear for at least the 30 s-55 nm that multiple peaks are observed/broadband. This is also the case for the 100 nm data set. Given the trend, I have reason to believe that this too would be the case for the 150 nm data set.

When moving towards a much higher etching time of the underlying polystyrene nanosphere then there does not seem to be the same broadband trend (FIG. 13 b). There is reason to believe therefore that there may exist a limit for each given underlying polystyrene nanosphere size at which the interesting broadband spectra either ceases to exist or is just not apparent. Because of this smaller size, it may also be that the capped structure begins to be lost. However, it is readily apparent that a diverse array of suitable chips comprising appropriate nanostructures that deliver enhanced broadband fluorescence can be generated.

Given that it has already been shown that you can still get this broad band spectra with NO etching (FIG. 13, gold example), but that there appears to be a limit to when this will occur.

### Example 5—not all Capped Nanostructures Produce Multiple Peaks

FIG. 14:
A—This is using smaller polystyrene spheres (PS252) with gold, can see there is not the same multiple peak trend observed.
B—This is using PS 251 with much thinner amounts of silver (3 nm), only one peak is observed here, no broadband
C—Again using PS 252, only one main plasmonic peak observed for copper coated at different thicknesses.

1. A chip comprising a solid substrate and a plurality of nanostructures
wherein the plurality of nanostructures are arranged on the surface of the solid substrate,
and wherein the nanostructures comprise a dielectric core partially coated in a metallic plasmonic material.

2. The chip according to claim 1 wherein the partial coating of the metallic plasmonic material forms a cap structure on the dielectric core, optionally wherein the cap structure is positioned distal to the portion of the dielectric core that contacts the surface of the solid substrate.

3. The chip of claim 1 wherein a portion of the dielectric core remains exposed, i.e. a portion of the dielectric core that is not coated with the metallic plasmonic material and is not in contact with the solid substrate, optionally wherein distance (g) is not coated with the metallic plasmonic material.

4. The chip of claim 1 wherein at least a portion of the plurality of nanostructures is arranged upon said substrate to form a first array, optionally a first regular array of nanostructures, optionally where all nanostructures are arrayed in the same regular array, optionally, wherein the first array is a close packed array, optionally a hexagonal close packed array (hcp) or face centred cuboid (fcc).

5. The chip of claim 1, wherein each nanostructure of the plurality of nanostructures comprises the same:
a) dielectric core; and/or
b) metallic material.

6. The chip of claim 1, wherein the dielectric material is a polymer, optionally wherein the polymer is polystyrene, silica or any combination thereof, optionally wherein the dielectric core is polystyrene.

7. The chip of claim 1, wherein the metallic material is selected from:
a) a noble metal;
b) a base metal, or a salt thereof;
c) a plasmonic material;
d) silver, gold, copper, and aluminium;
e) d) silver, gold and aluminium; and
f) silver;
or any combination thereof.

8. The chip of claim 1, wherein:
at least 30%, 35%, 40%, 45%, 50%, 55%, 60%, 65%, 70%, 75%, 80%, 85%, 90%, 95%, 96%, 97%, 98%, 99%, 100% of the surface of each of the dielectric cores is coated with the metallic material; and/or
wherein less than 100%, 99%, 98%, 97%, 96%, 95%, 90%, 85%, 80%, 75%, 70%, 65%, 60%, 55%, 50%, 45%, 40%, 35%, 30% of the surface of each of the dielectric cores is coated with the metallic material; and/or
wherein each of the dielectric cores is not 100% coated in the metallic plasmonic material.

9. The chip of claim 1, wherein the average diameter (a) of each metallic material-coated nanostructure of the plurality of nanostructures is:
from 1 nm to 1000 nm, optionally from 50 nm to 900 nm; 100 nm to 800 nm; 200 nm to 700 nm; 300 nm to 600 nm, 400 to 500 nm; and/or
at least 1 nm, 50 nm, 100 nm, 200 nm, 300 nm, 400 nm, 500 nm, 600 nm, 700 nm, 800 nm, 900 nm and 1000 nm; and/or
less than 1000 nm, 900 nm, 800 nm, 700 nm, 600 nm, 500 nm, 400 m, 300 nm, 200 nm, 100 nm, 50 nm, 25 nm, or 5 nm, or 1 nm.

10. The chip of claim 1 wherein the average diameter of the dielectric core is:
from 1 nm to 1000 nm, optionally from 50 nm to 900 nm; 100 nm to 800 nm; 200 nm to 700 nm; 300 nm to 600 nm, 400 to 500 nm; and/or
at least 1 nm, 50 nm, 100 nm, 200 nm, 300 nm, 400 nm, 500 nm, 600 nm, 700 nm, 800 nm, 900 nm and 1000 nm; and/or
less than 1000 nm, 900 nm, 800 nm, 700 nm, 600 nm, 500 nm, 400 m, 300 nm, 200 nm, 100 nm, 50 nm, 25 nm, or 5 nm, or 1 nm.

11. The chip of claim 1, wherein the metal coating has an average maximum average thickness of:
at least 1 nm, 2, 3, 4, 5, 6, 7, 8, 9, 10, 11, 12, 13, 14, 15, 20, 30, 40, 50, 60, 70, 80, 90, 100, 150, 200, 250, 300, 350, 400, 450, 500, 550, 600, 650, 700, 750, 800, 850, 900, 950 or at least 1000 nm; and/or
less than 1000 nm, 950, 900, 850, 800, 750, 700, 650, 600, 550, 500, 450, 400, 350, 300, 250, 200, 150, 100, 90, 80, 70, 60, 50, 40, 30, 20, 15, 14, 13, 12, 11, 10, 9, 8, 7, 6, 5, 4, 3, 2 or 1 nm; and/or
from 1 nm to 1000 nm, 2 to 950, 3 to 900, 4 to 850, 5 to 800, 6 to 750, 7 to 700, 8 to 650, 9 to 600, 10 to 550, 11 to 500, 12 to 450, 13 to 400, 14 to 350, 15 to 300, 20 to 250, 30 to 200, 40 to 150, 50 to 100, 60 to 90, 70 to 80 nm.

12. The chip of claim 1, wherein the nanostructures have a shape selected from the group consisting of spherical, substantially spherical, star-shaped, ovoid, pyramidal, cube, and cuboid or any combination thereof, optionally wherein the nanostructures are spherical or substantially spherical or star-shaped.

13. The chip of claim 1, wherein exposure of the chip to light induces the formation of one or more surface plasmons within a portion of the chip, optionally wherein the surface plasmon forms on the surface of the metallic material that coats the nanostructure,
optionally wherein the light is selected from the group consisting of ultraviolet (UV) light, visible light, near-infra-red (NIR) light, and NIR-II light, or any combination thereof, optionally wherein UV light has a wavelength of between 100-400 nm; visible light has a wavelength of between 380-700; NIR I has a wavelength of between 650-900 nm; and NIR II has a wavelength of between 1000-1400 nm.

14. The chip of claim 1, wherein exposure of the chip to light with a wavelength from at least two different spectral regions induces the formation of a surface plasmon within a portion of the chip, optionally wherein the spectral regions are selected from the group consisting of ultraviolet (UV) light, visible light, near-infra-red (NIR) light, and NIR-II light, or any combination thereof, optionally wherein UV spectral region has a wavelength of between 100-400 nm; the visible spectral region has a wavelength of between 380-700 nm; NIR I spectral region has a wavelength of between 650-900 nm; and NIR II spectral region has a wavelength of between 1000-1400 nm,
optionally wherein the excitation light has a wavelength of between 10 nm and 1400 nm, optionally wherein the excitation light has a wavelength selected from the group consisting of between 10 nm and 400 nm, between 400 nm and 700 nm, between 700 nm and 1000 nm, between 1000 nm and 1400 nm, and between 350 nm and 1400 nm.

15. The chip of claim 1, wherein a capture agent capable of binding specifically to a target analyte is bound to the chip, optionally bound to the substrate, the metal film coating the substrate, and/or to the nanostructures,
optionally wherein the capture agent is:
a protein, optionally wherein the protein is selected from the group consisting of an antibody or antigen binding fragment thereof, actin, albumin, casein, collagen, dystrophin, fibrinogen, fibronectin, flagellin, gelatin, keratin, α-lactalbumin, β-lactalbumin, lactoferrin, myosin, titin, and tubulin, or any combination thereof; or
a nucleic acid, optionally wherein the nucleic acid is DNA or RNA, optionally wherein
the DNA is selected from the group consisting of cccDNA, ccfDNA, cDNA, cfDNA, cffDNA, circular DNA, cpDNA, ctDNA, dsDNA, eccDNA, ecDNA, eDNA, exogenous DNA, gDNA, i-DNA, linker DNA, microDNA, mtDNA, msDNA, ncDNA, rDNA, and ssDNA, or any combination thereof; and/or
the RNA is selected from the group consisting of 7SK RNA, asRNA, cfRNA, circRNA, crRNA, diRNA, dsRNA, eRNA, exRNA, gRNA, lncRNA, miRNA, natsiRNA, ncRNA, piRNA, pre-mRNA, rasiRNA, RNase MRP, RNase P, rRNA, scaRNA, sgRNA, shRNA, siRNA, SL RNA, SmY RNA, snRNA, snoRNA, ssRNA, tasiRNA, telomerase RNA, tmRNA, tRNA, tracrRNA, and Y RNA, or any combination thereof.

16. The chip of claim 1, wherein the chip is in the form of a slide, a dish, a lateral flow strip, a multi-well plate for example a standard multi-well plate, such as a 48 or 96 well plate, or a bead coated with the nanostructures according to any of the proceeding claims.

17. The chip of claim 1, wherein the chip is capable of enhancing the fluorescence of one or more fluorophores, including inorganic/Organic fluorophores, emitting in UV, visible and NIR optical windows, optionally wherein the one or more fluorophore is selected from:
Alexa Fluor™ dyes, Single-Walled Carbon Nanotubes (SWCNTs), Quantum Dots, Rare-Earth-Doped Nanoparticles (RENPs) including upconversion nanoparticles and downconversion nanoparticles, optionally wherein the chip is capable of enhancing the fluorescence from each flurophore simultaneously or sequentially.

18. The chip of claim 1, wherein the chip has been produced using a method that comprises:
a) arranging nanoparticles of a dielectric material on the surface of a substrate;
b) etching the dielectric nanoparticles to form a dielectric core, optionally wherein the etching is performed using oxygen plasma (RIE); and
c) depositing a metallic material on the dielectric core to form metallic-capped nanostructures, optionally wherein said depositing is by sputtering.

19-23. (canceled)

24. A method of detecting a target analyte wherein the method comprises detecting the analyte using the chip according to claim 1.

25. (canceled)

26. The method according to claim 24, wherein the method comprises the detection of a plurality of target analytes, optionally wherein the method comprises the detection of at least two, at least three, at least four, at least five, or at least six target analytes.

27-31. (canceled)

32. A kit comprising the chip of claim 1, and one or more of:
One or more corresponding fluorophores; and/or
One or more fluorophore labelled oligonucleotides; and/or
One or more fluorophore labelled antibodies or antigen binding fragments thereof,
optionally wherein the kit comprises 2, 3 or 4 or more fluorophores or fluorophore labelled oligonucleotides or antibody or antigen binding fragments thereof where the max excitation of the two or more fluorophores are in different spectral regions.

33. The chip according to claim 1, wherein the partial coating of the metallic plasmonic material forms a cap structure on the dielectric core, and wherein the cap structure is positioned distal to the portion of the dielectric core that contacts the surface of the solid substrate.
